(19) United States
(12) Patent Application Publication
(10) Pub. No.: US 2025/0108617 A1
(43) Pub. Date: Apr. 3, 2025

(54) LIQUID DISCHARGE DEVICE

(71) Applicant: BROTHER KOGYO KABUSHIKI KAISHA, Nagoya (JP)

(72) Inventors: Mikio OGAWA, Nagoya (JP); Hiroyuki TANAKA, Inazawa (JP); Ryuji KATO, Kiyosu (JP)

(73) Assignee: BROTHER KOGYO KABUSHIKI KAISHA, Nagoya (JP)

(21) Appl. No.: 18/897,109

(22) Filed: Sep. 26, 2024

(30) Foreign Application Priority Data
Sep. 29, 2023 (JP) 2023-170140

(51) Int. Cl. B41J 2/165; B41J 11/06; B41J 11/14

(52) U.S. Cl. CPC B41J 2/16544; B41J 2/1652; B41J 2/16538; B41J 11/06; B41J 11/14; B41J 2002/16573; B41P 2235/21

(57) ABSTRACT

A liquid discharge device includes: a head configured to discharge a liquid from a nozzle opening on a nozzle surface; a wiper configured to be brought into contact with the nozzle surface at a front surface of the wiper and be movable relative to the head in a first direction; a support portion configured to support at least a rear surface of the wiper and be movable relative to the wiper in a second direction intersecting the nozzle surface and the first direction; and a controller configured to: acquire an elapsed time from when the liquid is discharged from the nozzle; determine, based on the elapsed time, a first support position which is a position of the support portion in the second direction; and position the support portion at the determined first support position, and move the wiper relative to the head in the first direction.

### REFERENCE TO RELATED APPLICATIONS

This application claims priority from Japanese Patent Application No. 2023-170140 filed on Sep. 29, 2023. The entire content of the priority application is incorporated herein by reference.

### BACKGROUND ART

The present disclosure relates to a liquid discharging device.

A related-art inkjet recording device includes nozzles that dispense ink, a nozzle plate in which a plurality of nozzles are formed, a wiper blade that wipes a surface of the nozzle plate, a support portion that adjusts a degree of deformation of the wiper blade by being moved up and down on a back surface of the wiper blade, and a support portion height information storage portion that stores height information of the support portion, the height information having contents of how much the support portion is exposed from a holder.

### SUMMARY

According to an aspect of the present disclosure, a liquid discharge device includes: a head configured to discharge a liquid from a nozzle opening on a nozzle surface; a wiper configured to be brought into contact with the nozzle surface at a front, in a first direction, surface of the wiper and be movable relative to the head in the first direction; a support portion configured to support at least a rear, in the first direction, surface of the wiper and be movable relative to the wiper in a second direction intersecting the nozzle surface and the first direction; and a controller. The controller is configured to: acquire an elapsed time from when the liquid is discharged from the nozzle; determine, based on the elapsed time, a first support position which is a position of the support portion in the second direction; and position the support portion at the determined first support position, and move the wiper relative to the head in the first direction.

According to another aspect of the present disclosure, a liquid discharge device includes: a head configured to discharge a liquid from a nozzle opening on a nozzle surface; a wiper configured to be brought into contact with the nozzle surface at a front, in a first direction, surface of the wiper and be movable relative to the head in the first direction; a support portion configured to support at least a rear, in the first direction, surface of the wiper and be movable relative to the wiper in a second direction intersecting the nozzle surface and the first direction; a storage medium configured to store liquid type information related to the liquid discharged by the head; and a controller. The controller is configured to: acquire the liquid type information from the storage medium; determine, based on the liquid type information, a third support position which is a position of the support portion in the second direction; and position the support portion at the determined third support position and move the wiper in the first direction relative to the head.

According to a further aspect of the present disclosure, a liquid discharge device includes: a head configured to discharge a liquid from a nozzle opening on a nozzle surface; a frame surrounding the nozzle surface; a wiper configured to be brought into contact with the nozzle surface at a front, in a first direction, surface of the wiper and the frame and be movable relative to the head in the first direction; a support portion configured to support at least a rear, in the first direction, surface of the wiper and be movable relative to the head in a second direction intersecting with the nozzle surface and the first direction; an encoder configured to output a signal indicating a relative position of the wiper relative to the head; and a controller. The controller is configured to: position, on a condition that it is determined that the wiper is located in a boundary region between the nozzle surface and the frame based on the signal output from the encoder, the support portion at a fifth support position, and move the wiper relative to the head in the first direction, and position, after the wiper is moved in the first direction, on a condition that it is determined that the wiper is not located in the boundary region based on the signal output from the encoder, the support portion at a sixth support position, and moves the wiper relative to the head in the first direction, the sixth support position being closer to the nozzle surface than the fifth support position in the second direction and faces the nozzle surface.

### BRIEF DESCRIPTION OF DRAWINGS

A more complete appreciation of the disclosure and many of the attendant advantages thereof will be readily obtained as the same becomes better understood by reference to the following detailed description when considered in connection with the accompanying drawings.

FIG. 1 is an external perspective view of an image recording device 100 according to an embodiment of the present disclosure.

FIG. 2 is a cross-sectional view taken along a line II-II in FIG. 1, showing a state in which a head 38 is in a recording position, a first support mechanism 51 is in a first posture, and a maintenance mechanism 60 is in a standby position.

FIG. 3 is a cross-sectional view showing a state in which an upper housing 31 in FIG. 2 is in an open position.

FIG. 4 is a block diagram of the image recording device 100.

FIG. 5 is a cross-sectional view showing a state in which the maintenance mechanism 60 is located at the standby position.

FIG. 6 is a cross-sectional view showing a state in which the maintenance mechanism 60 is located at a maintenance position.

FIG. 7 is a cross-sectional view showing a state in which the maintenance mechanism 60 is located at a wiping position.

FIG. 8 is a flowchart for illustrating maintenance control.

FIG. 9 is a flowchart for illustrating control of the maintenance mechanism 60 based on an elapsed time.

FIGS. 10A and 10B are diagrams showing states in which a support portion 75 is located at a first support position P1 and a second support position P2.

FIG. 11 is a flowchart for illustrating a wiping process.

FIGS. 12A to 12G are diagrams for illustrating an operation of the support portion 75 in the wiping process.

FIG. 13 is a flowchart for illustrating control of the maintenance mechanism 60 when the image recording device 100 according to Modification 1 records an image using a polymer-containing liquid.

FIG. 14 is a flowchart for illustrating the control of the maintenance mechanism 60 when the image recording device 100 according to Modification 1 records an image using a polymer-free liquid.

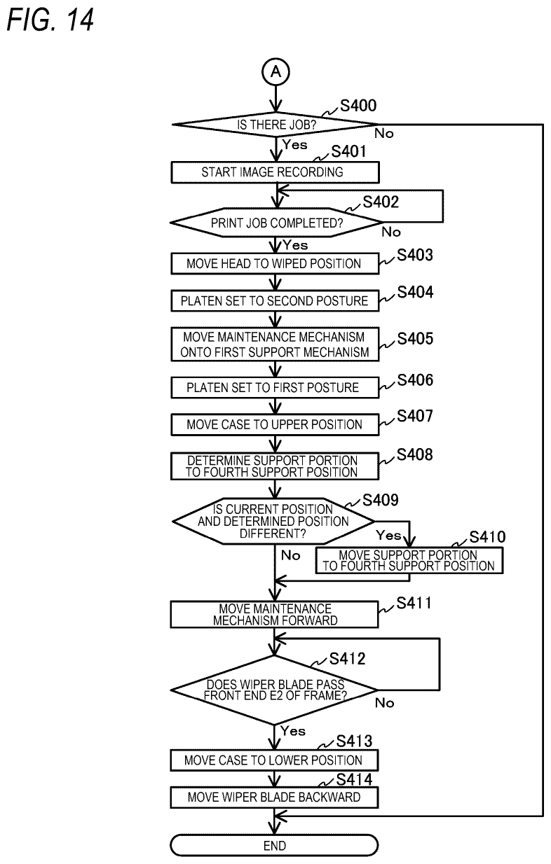

FIGS. 15A and 15B are diagrams showing states in which the support portion 75 is located at a third support position P3 and a fourth support position P4 in the image recording device 100 according to Modification 1.

FIG. 16 is a flowchart for illustrating control of the maintenance mechanism 60 of the image recording device 100 according to Modification 2.

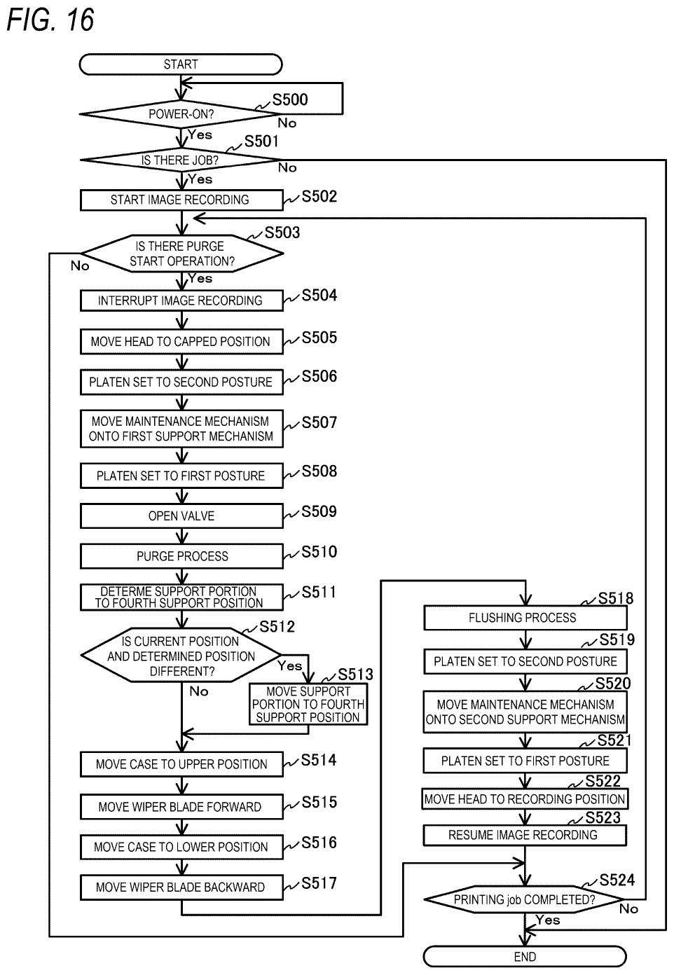

FIG. 17 is an external perspective view of an image recording device 100a according to Modification 3.

FIG. 18 is a flowchart for illustrating control by which a maintenance mechanism 60a wipes a first head 38a and a second head 38b.

FIG. 19 is a flowchart for illustrating the control by which the maintenance mechanism 60a wipes the first head 38a and the second head 38b.

FIGS. 20A to 20E are diagrams for illustrating an operation of a support portion 75a.

### DESCRIPTION

In the related-art inkjet recording device, when the number of times of a user cleaning operation reaches three times, the height of the support portion increases. Accordingly, a pressing force of the wiper blade against the nozzle plate is increased. However, a time, a recording medium, and ink may be consumed more as the user cleaning operation is repeatedly executed.

In addition, in the inkjet recording device, if there is a step between the nozzle plate and a frame, the wiper blade may collide with the step, and the wiper blade may deteriorate or the ink may be scattered from the wiper blade.

As used herein, the words “a” and “an” and the like carry the meaning of “one or more.
(1) A liquid discharge device according to an embodiment of the present disclosure includes: a head configured to discharge a liquid from a nozzle opening on a nozzle surface; a wiper configured to be brought into contact with the nozzle surface and be movable relative to the head in a first direction; a support portion configured to support at least a rear surface of the wiper in the first direction and be movable relative to the wiper in a second direction intersecting the nozzle surface; and a controller, wherein the controller is configured to: acquire an elapsed time from when the liquid is discharged from the nozzle; determine, based on the elapsed time, a first support position which is a position of the support portion in the second direction; and position the support portion at the determined first support position, and move the wiper relative to the head in the first direction.

The controller determines the first support position of the support portion based on the elapsed time from the discharge of the ink. Depending on the first support position of the support portion, a deformation amount of the wiper when wiping the nozzle surface changes. The pressing force of the wiper against the nozzle surface changes depending on the deformation amount of the wiper.
(2) The controller may be configured to: determine the first support position based on the elapsed time being equal to or greater than a threshold value; determine, based on the elapsed time being less than the threshold value, a position of the support portion in the second direction to be a second support position farther from the nozzle surface than the first support position; and position the support portion at the determined first support position or the determined second support position, and move the wiper relative to the head in the first direction.
(3) The liquid discharge device may further include a platen configured to be able to face the head, wherein the support portion is moved in the second direction without changing a distance between the head and the platen in the second direction.

Since the support portion moves in a state in which the distance between the platen and the nozzle surface is constant, the pressing force of the wiper is determined only by the position of the support portion.
(4) The controller may be configured to: execute purge to discharge the liquid from the nozzle; and position, after the purge is completed, the support portion at the second support position and moves the wiper relative to the head in the first direction.

The support portion is closer to the nozzle surface at the first support position than at the second support position. Therefore, the pressing force of the wiper against the nozzle surface is larger at the end of printing than at the end of purge.
(5) A liquid discharge device may include: a head configured to discharge a liquid from a nozzle opening on a nozzle surface; a wiper configured to be brought into contact with the nozzle surface and be movable relative to the head in a first direction; a support portion configured to support at least a rear surface of the wiper in the first direction and be movable relative to the wiper in a second direction intersecting the nozzle surface; a storage medium configured to store liquid type information related to the liquid discharged by the head; and a controller, wherein the controller is configured to: acquire the liquid type information from the storage medium; determine, based on the liquid type information, a third support position which is a position of the support portion in the second direction; and position the support portion at the determined third support position and move the wiper in the first direction relative to the head.

The controller determines the third support position of the support portion based on the liquid type information. The deformation amount of the wiper when wiping the nozzle surface changes depending on the third support position of the support portion, and the pressing force of the wiper against the nozzle surface changes depending on the deformation amount of the wiper.
(6) The controller may be configured to: determine the third support position based on the liquid type information being first information; determine, based on the liquid type information being second information different from the first information, the position of the support portion in the second direction to be a fourth support position farther from the nozzle surface than the third support position; and position the support portion at the determined third support position or the fourth support position, and move the wiper relative to the head in the first direction.
(7) The liquid discharge device may further include: a platen configured to be able to face the head, wherein the support portion is moved in the second direction without changing a distance between the head and the platen in the second direction.
(8) The first information may be information indicating that the liquid is a polymer-containing liquid, and the second information may be information indicating that the liquid is a polymer-free liquid.

The support portion is closer to the nozzle surface at the third support position than at the fourth support position. Therefore, the pressing force of the wiper against the nozzle surface is larger when the liquid is the polymer-containing liquid than when the liquid is the polymer-free liquid.
(9) The liquid discharge device may further include a case configured to be able to accommodate the support portion, wherein the support portion is accommodated in the case at the fourth support position.

When the liquid is the polymer-free liquid, the support portion is in a state of being accommodated in the case.
(10) The liquid discharge device may be configured as follows, wherein the head includes a first head and a second head, wherein the wiper is movable in the first direction relative to the first head and the second head, wherein the first head discharges the polymer-containing liquid, wherein the second head discharges the polymer-free liquid, wherein the wiper is moved in the first direction relative to the first head with the position of the support portion located at the third support position relative to the first head, and wherein the wiper is moved in the first direction relative to the second head with the position of the support portion located at the fourth support position relative to the second head.

The polymer-containing liquid can be discharged exclusively from the first head, and the polymer-free liquid can be discharged exclusively from the second head. At this time, it is possible to reliably wipe solidified ink by making the pressing force of the wiper against the first head stronger than that of the second head.
(11) the polymer-containing liquid may be latex ink, and the polymer-free liquid may be a pretreatment agent printed with the latex ink.

The latex ink and the pretreatment agent can be discharged separately in the first head and the second head.
(12) A liquid discharge device may include: a head configured to discharge a liquid from a nozzle opening on a nozzle surface; a frame surrounding the nozzle surface; a wiper configured to be brought into contact with the nozzle surface and the frame and be movable relative to the head in a first direction; a support portion configured to support at least a rear surface of the wiper in the first direction and be movable relative to the head in a second direction intersecting with the nozzle surface; an encoder configured to output a signal indicating a relative position of the wiper relative to the head; and a controller, wherein the controller is configured to: position, on a condition that it is determined that the wiper is located in a boundary region between the nozzle surface and the frame based on the signal output from the encoder, the support portion at a fifth support position, and move the wiper relative to the head in the first direction, and position, after the wiper is moved in the first direction, on a condition that it is determined that the wiper is not located in the boundary region based on the signal output from the encoder, the support portion at a sixth support position, and moves the wiper relative to the head in the first direction, the sixth support position being closer to the nozzle surface than the fifth support position in the second direction and faces the nozzle surface.

The controller positions the support portion at the fifth support position when the wiper is located in the boundary region. When the wiper is further moved in the first direction and no longer located in the boundary region, the controller positions the support portion at the sixth support position.
(13) The liquid discharge device may further include: a platen configured to be able to face the head, wherein the support portion is moved in the second direction without changing a distance between the head and the platen in the second direction.
(14) The frame may protrude from the nozzle surface toward the platen in the second direction.

When the wiper moves in the first direction, the wiper moves to the frame forming a step relative to the nozzle surface.
(15) A first speed at which the wiper moves relative to the head may be constant.
(16) A second speed at which the support portion is moved in the second direction may be higher than the first speed.
(17) The controller may be configured to: acquire an elapsed time from when the liquid is discharged from the nozzle; and determine the third support position based on the liquid type information and the elapsed time.

The controller determines the position of the support portion based on the liquid type information and the elapsed time.
(18) The liquid discharge device may further include a platen configured to be able to face the head, wherein the support portion is moved in the second direction without changing a distance between the head and the platen in the second direction.
(19) The controller may be configured to: execute purge for discharging the liquid from the nozzle; and position, after the purge is completed, the support portion at a fourth support position farther from the nozzle surface than the third support position, and move the wiper relative to the head in the first direction.
(20) The liquid discharge device may further include: a frame surrounding the nozzle surface; the wiper configured to be brought into contact with the nozzle surface and the frame; and an encoder configured to output a signal indicating a relative position of the wiper relative to the head, wherein the controller is configured to: position, on a condition that it is determined that the wiper is located in a boundary region between the nozzle surface and the frame based on the signal output from the encoder, the support portion at a fourth support position farther from the nozzle surface than the third support position, and move the wiper relative to the head in the first direction; and position, after the wiper is moved in the first direction, on a condition that it is determined that the wiper is not located in the boundary region based on the signal output from the encoder, the support portion at the third support position, and move the wiper relative to the head in the first direction.

The controller determines the position of the support portion based on the liquid type information, the elapsed time, and the boundary region.

According to the present disclosure, it is possible to appropriately adjust the pressing force of the wiper against the nozzle surface.

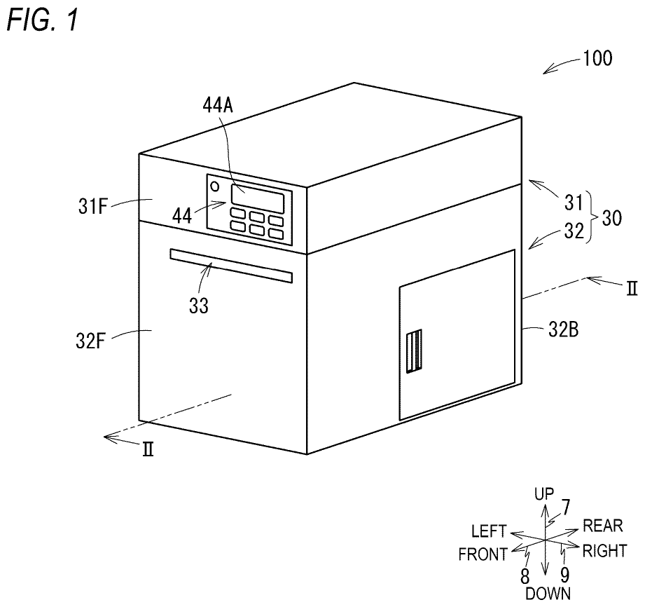

Hereinafter, a preferred embodiment of the present disclosure will be described. The present embodiment is merely one embodiment of the invention, and it is needless to say that the embodiment can be modified without changing the gist of the invention. In addition, in the following description, advancement from a start point to an end point of an arrow is expressed as an orientation, and movement on a line connecting the start point and the end point of the arrow is expressed as a direction. In the following description, an up-down direction 7 is defined with reference to a state in which the image recording device 100 is installed to be usable (state in FIG. 1), a front-rear direction 8 is defined with a side where a discharge port 33 is provided as a front side (front surface), and a left-right direction 9 is defined when the image recording device 100 is viewed from the front side (front surface). The front-rear direction 8 is an example of a first direction.

### Appearance Configuration of Image Recording Device 100

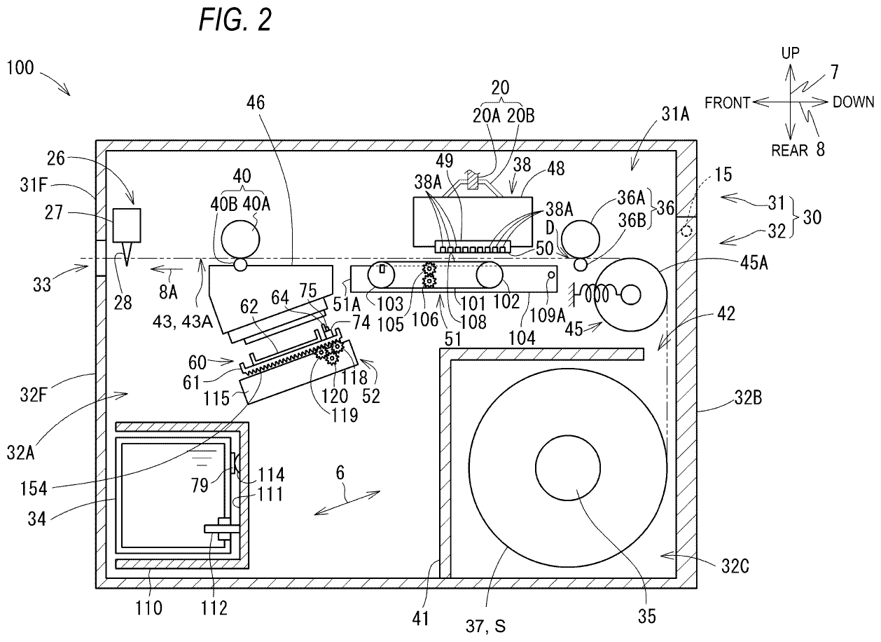

The image recording device (an example of a liquid discharge device) 100 shown in FIG. 1 records an image on a sheet S forming a roll body 37 (see FIG. 2) using an inkjet recording method. The image recording device 100 is an example of an inkjet printer.

As shown in FIG. 1, the image recording device 100 includes a housing 30. The housing 30 includes an upper housing 31 and a lower housing 32. The upper housing 31 and lower housing 32 have a substantially rectangular parallelepiped shape as a whole and have a size capable of being placed on a table. That is, the image recording device 100 is suitable for being placed on a table and used. Of course, the image recording device 100 may be placed on a floor or a rack for use.

As shown in FIG. 2, the housing 30 has an internal space 31A inside the upper housing 31 and an internal space 32A inside the lower housing 32, which is defined from outside.

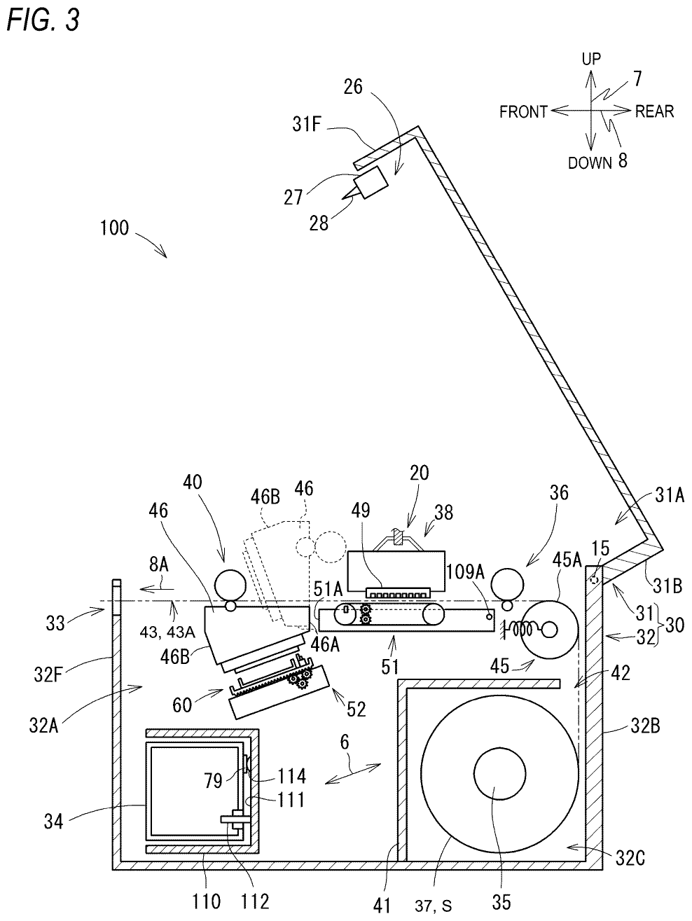

As shown in FIGS. 2 and 3, the upper housing 31 is pivotably supported by the lower housing 32. The upper housing 31 is pivotable between a closed position shown in FIG. 2 and an open position shown in FIG. 3 around a pivot shaft 15 which is provided on a lower rear end portion and extends in the left-right direction 9.

As shown in FIG. 1, the slit-shaped discharge port 33 elongated in the left-right direction 9 is formed in a front surface 32F of the lower housing 32. The image-recorded sheet S (see FIG. 2) is discharged from the discharge port 33.

An operation panel 44 is provided on a front surface 31F of the upper housing 31. A user performs an input on the operation panel 44 to operate the image recording device 100 or confirm various settings. The operation panel 44 includes a display unit 44A. The display unit 44A displays that a tank 34 is mounted in a mounting case 110.

### Internal Configuration of Image Recording Device 100

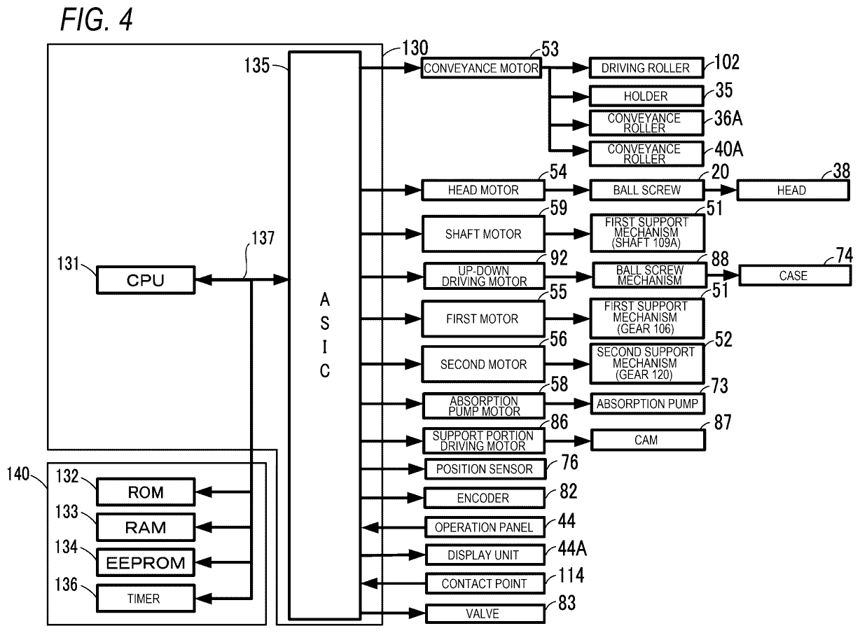

As shown in FIG. 2, a holder 35, a tensioner 45, a conveyance roller pair 36, a conveyance roller pair 40, the head 38, the first support mechanism 51, a support body 46, a second support mechanism 52, a cutter unit 26, the tank 34, and the maintenance mechanism 60 are disposed in the internal spaces 31A and 32A. Although not shown in FIG. 2, a controller 130 (see FIG. 4) is disposed in the internal space 32A. The controller 130 controls an operation of the image recording device 100.

A partition wall 41 is provided in the internal space 32A. The partition wall 41 partitions a rear lower portion of the internal space 32A to define a sheet accommodating space 32C. The sheet accommodating space 32C is surrounded by the partition wall 41 and the lower housing 32.

The roll body 37 is accommodated in the sheet accommodating space 32C. The roll body 37 includes a core tube and the elongated sheet S. The sheet S is wound around the core tube in a roll shape in a circumferential direction of an axis of the core tube.

As shown in FIG. 2, the holder 35 extending in the left-right direction 9 is located in the sheet accommodating space 32C. When the roll body 37 is mounted, the holder 35 supports the roll body 37 such that the axis of the core tube of the roll body 37 extends along the left-right direction 9 and the roll body 37 is rotatable in the circumferential direction of the axis. The holder 35 is rotated by a driving force transmitted from a conveyance motor 53 (see FIG. 4). As the holder 35 rotates, the roll body 37 supported by the holder 35 also rotates.

The sheet accommodating space 32C opens upward at a rear portion thereof. A gap 42 is formed between the partition wall 41 and a rear surface 32B, that is, above a trailing end of the roll body 37. When the conveyance roller pairs 36 and 40 rotate, the sheet S is pulled out upward from the trailing end of the roll body 37 and guided to the tensioner 45 through the gap 42.

The tensioner 45 is located above the partition wall 41 in a rear portion of the internal space 32A. The tensioner 45 has an outer circumferential surface 45A facing the outside of the lower housing body 32. An upper end of the outer circumferential surface 45A is located at substantially the same upper and lower position as a nip D of the conveyance roller pair 36 in the up-down direction 7.

The sheet S pulled out from the roll body 37 is hung on and brought into contact with the outer circumferential surface 45A. The sheet S is curved forward along the outer circumferential surface 45A, extends in a conveyance orientation 8A, and is guided to the conveyance roller pair 36. The conveyance orientation 8A is a forward orientation along the front-rear direction 8.

The conveyance roller pair 36 is located in front of the tensioner 45. The conveyance roller pair 36 includes a conveyance roller 36A and a pinch roller 36B. The conveyance roller 36A and the pinch roller 36B are in contact with each other at substantially the same upper and lower position as the upper end of the outer circumferential surface 45A to form the nip D.

A conveyance roller pair 40 is located in front of the conveyance roller pair 36. The conveyance roller pair 40 includes a conveyance roller 40A and a pinch roller 40B. The conveyance roller 40A and the pinch roller 40B are in contact with each other at substantially the same upper and lower position as the upper end of the outer circumferential surface 45A to form a nip.

The conveyance rollers 36A and 40A are rotated by a driving force transmitted from the conveyance motor 53 (see FIG. 4). The conveyance roller pair 36 rotates while nipping the sheet S extending from the tensioner 45 in the conveyance orientation 8A, thereby feeding the sheet S in the conveyance orientation 8A along a conveyance surface 43A of a conveyance path 43 to be described later. The conveyance roller pair 40 rotates while nipping the sheet S fed from the conveyance roller pair 36, thereby feeding the sheet S in the conveyance orientation 8A. By the rotation of the conveyance roller pairs 36 and 40, the sheet S is pulled out from the sheet accommodating space 32C toward the tensioner 45 through the gap 42.

As shown in FIG. 2, the conveyance path 43 extending from the upper end of the outer circumferential surface 45A to the discharge port 33 is formed in the internal space 32A. The conveyance path 43 extends substantially linearly along the conveyance orientation 8A, and is a space through which the sheet S can pass. Specifically, the conveyance path 43 extends along the conveyance surface 43A that spreads in the conveyance orientation 8A and the left-right direction 9 and is long in the conveyance orientation 8A. In FIG. 2, the conveyance surface 43A is indicated by a two-dot chain line indicating the conveyance path 43. The conveyance path 43 is defined by a guide member (not shown), the head 38, a conveyance belt 101, the support body 46, and the like, which are located apart from each other in the up-down direction 7. That is, the head 38, the conveyance belt 101, and the support body 46 are located along the conveyance path 43.

The head 38 is located above the conveyance path 43 and downstream of the conveyance roller pair 36 in the conveyance orientation 8A. The head 38 has a plurality of nozzles 39 that open in a nozzle surface 50. Ink is discharged downward from the plurality of nozzles 39 toward the sheet S supported by the conveyance belt 101 (when the ink is dispensed from the nozzles 39 by a piezoelectric element (not shown)). Accordingly, an image is recorded on the sheet S. A configuration of the head 38 will be described later. It is assumed that the ink is discharged from the head 38 when the piezoelectric element is driven by the controller 130 and ink droplets are dispensed from the nozzles 39 as described above, and when the ink is discharged from the nozzles 39 by pressure application or absorption in a state in which a cap 62 is in close contact with the nozzle surface 50 in a purge process.

The first support mechanism 51 is located below the conveyance path 43 and downstream of the conveyance roller pair 36 in the conveyance orientation 8A. The first support mechanism 51 is located below the head 38 and faces the head 38. The first support mechanism 51 includes a conveyance belt 101, a driving roller 102, a driven roller 103, a platen 104, a gear 105, and a gear 106. The conveyance belt 101 supports the sheet S that is conveyed in the conveyance orientation 8A by the conveyance roller pair 36 and is located immediately below the head 38. The conveyance belt 101 conveys the supported sheet S in the conveyance orientation 8A. The platen 104 can support the maintenance mechanism 60.

The driving roller 102 and the driven roller 103 are rotatably supported by the platen 104. The driving roller 102 and the driven roller 103 are spaced apart from each other in the front-rear direction 8 (the conveyance orientation 8A). The conveyance belt 101 is an endless belt. The conveyance belt 101 is stretched around the driving roller 102 and the driven roller 103. The conveyance belt 101 is disposed in the conveyance path 43 in the left-right direction 9.

The driving roller 102 is rotated by a driving force applied by the conveyance motor 53 (see FIG. 4) to rotate the conveyance belt 101. As the conveyance belt 101 rotates, the driven roller 103 rotates. The conveyance belt 101 has a conveyance surface 108. The conveyance surface 108 is an upper portion of the outer circumferential surface of the conveyance belt 101 and extends along the conveyance orientation 8A. The conveyance surface 108 faces the nozzles 39 of the head 38 with the conveyance path 43 in between. The conveyance surface 108 applies a conveyance force to the sheet S while supporting the sheet S conveyed between the conveyance roller pairs 36 and 40 from below. Accordingly, the conveyance belt 101 conveys the sheet S located in the conveyance path 43 in the conveyance orientation 8A along the conveyance surface 108.

The platen 104 includes a shaft 109A. The shaft 109A is rotatably supported by the lower housing 32. The shaft 109A extends in the left-right direction 9 (a direction orthogonal to the conveyance orientation 8A and parallel to the nozzle surface 50 of a discharge module 49). The shaft 109A is disposed upstream of the driving roller 102 in the conveyance orientation 8A. The shaft 109A is located below the conveyance roller pair 36.

The shaft 109A is rotated by a driving force transmitted from a shaft motor 59 (see FIG. 4). The rotation of the shaft 109A causes the platen 104 to rotate around the shaft 109A. A pivot leading end 51A of the first support mechanism 51 is located downstream of the shaft 109A in the conveyance orientation 8A.

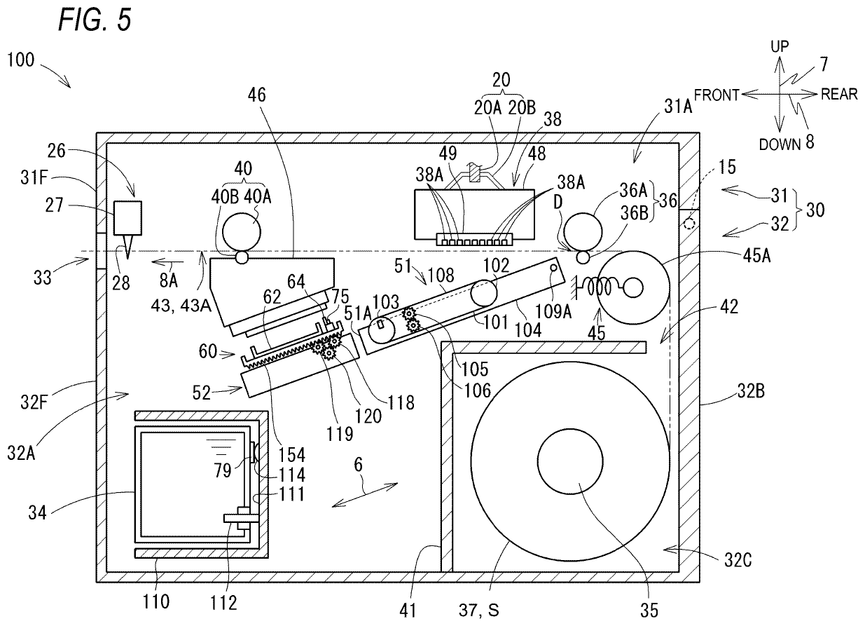

The platen 104 can change its posture between a first posture (see FIG. 2) in which the platen 104 is parallel to the nozzle surface 50 of the discharge module 49 and a second posture (see FIG. 5) in which the platen 104 is inclined about the shaft 109A from the first posture and the pivot leading end 51A is located below the shaft 109A.

As shown in FIG. 2, when the first support mechanism 51 is in the first posture, the conveyance surface 108 of the conveyance belt 101 extends along the front-rear direction 8. Accordingly, the conveyance belt 101 can convey the sheet S located in the conveyance path 43 forward to the support body 46.

As shown in FIG. 5, when the first support mechanism 51 is in the second posture, the conveyance surface 108 of the conveyance belt 101 extends along an inclined direction 6 that is downward toward the front. The inclined direction 6 is an orientation orthogonal to the left-right direction 9 and intersects the conveyance orientation 8A. In addition, one side along the inclined direction 6 is defined as a forward inclined direction 5, and the other side along the inclined direction 6 is defined as a backward inclined direction 4.

As shown in FIG. 2, the gears 105 and 106 are rotatably supported by the platen 104 of the first support mechanism 51. The gear 106 is connected to a first motor 55 (see FIG. 4) directly or via another gear or the like, and is applied with a driving force from the first motor 55.

The support body 46 is located below the conveyance path 43. The support body 46 is located downstream of the head 38 and the first support mechanism 51 in the conveyance orientation 8A. A front portion of the support body 46 faces the conveyance roller 40A. The support body 46 is located upstream of the cutter unit 26 in the conveyance orientation 8A.

The support body 46 is supported by the lower housing 32 to be pivotable about a shaft (not shown) extending in the left-right direction 9. As shown in FIG. 3, when the upper housing 31 is in the open position, the support body 46 is pivotable between a laid-down position indicated by a solid line in FIG. 3 and an upright position indicated by a broken line in FIG. 3.

When the support body 46 is in the laid-down position, a pivot leading end 46B of the support body 46 is located forward of a pivot base end 46A (downstream in the conveyance orientation 8A). When the support body 46 is in the laid-down position, the support body 46 constitutes a part of the conveyance path 43, and can support the sheet S conveyed in the conveyance orientation 8A by the conveyance belt 101. When the support body 46 is in the upright position, the pivot leading end 46B of the support body 46 is located higher than when the support body 46 is in the laid-down position, and the maintenance mechanism 60 can be exposed to the outside. A shaft of the support body 46 is provided at a trailing end portion of the support body 46 and extends in the left-right direction 9.

The second support mechanism 52 can support the maintenance mechanism 60 in a state along the inclined direction 6. The second support mechanism 52 supports the maintenance mechanism 60 and slidably supports a movement of the maintenance mechanism 60. The second support mechanism 52 is disposed to extend in the inclined direction 6 as a whole.

Gears 118, 119, and 120 are rotatably supported by a main body 115 of the second support mechanism 52. The gear 120 meshes with the gears 118 and 119. When the gear 120 rotates, the gears 118 and 119 rotate in the same direction. The gear 120 is connected to a second motor 56 (see FIG. 4) directly or via another gear or the like, and is applied with a driving force from the second motor 56. The gears 118 and 119 can mesh with a rack 154 of the maintenance mechanism 60 located at a facing position.

The maintenance mechanism 60 is for performing maintenance of the head 38. The maintenance mechanism 60 is implemented to be movable, and is moved to a position directly below the head 38 when the maintenance of the head 38 is performed.

The maintenance of the head 38 includes a purge process, a flushing process, and a wiping process. The purge process is a process in which the plurality of nozzles 39 are covered with the cap 62 (to be described later) of the maintenance mechanism 60, and then ink is discharged from the plurality of nozzles 39 (when the ink is absorbed from the nozzles 39) by a pump 73. The flushing process is a process of discharging the ink toward the cap 62. The wiping process is a process of wiping the nozzle surface 50 of the head 38 by a wiper blade (an example of a wiper) 64 (to be described later) of the maintenance mechanism 60. A configuration of the maintenance mechanism 60 will be described later.

The cutter unit 26 is located above the conveyance path 43 and downstream of the conveyance roller pair 40 in the conveyance orientation 8A. The cutter unit 26 includes a cutter 28 mounted on a cutter carriage 27. As the cutter 28 moves, the sheet S on the conveyance path 43 is cut along the left-right direction 9.

The mounting case 110 is located in the vicinity of a front end and a lower end of the lower housing body 32, and has a box shape that opens toward the front. The tank 34 is inserted rearward into the mounting case 110. An ink needle 112 extending forward is located on a rearward end surface 111 of the mounting case 110. A front end of the ink needle 112 is open, and a trailing end thereof is connected to an ink circuit (not shown). The ink circuit connects an internal space of the ink needle 112 and the head 38 so that the ink can flow therethrough. When the tank 34 is mounted in the mounting case 110, the ink needle 112 is inserted into an outlet of the tank 34. Accordingly, the ink stored in the tank 34 is supplied to the head 38 through the ink needle 112 and the ink circuit. A configuration of the ink circuit will be described later. A contact point 114 is located on the end surface 111. The contact point 114 is electrically connected to an IC board (an example of a storage medium) 79 of the tank 34 in a state in which the tank 34 is mounted in the mounting case 110. The controller 130 can access a storage area of the IC board 79 through the contact point 114. The IC board 79 stores liquid type information that is information on a type of ink stored in the tank 34.

The tank 34 stores ink. An internal space of the tank 34 is a storage chamber that stores ink. The storage chamber may be in communication with the outside in the atmosphere, or may be in the form of a bag, such as a pouch, which can be contracted when ink flows out. The ink is supplied from the tank 34 mounted in the mounting case 110 to the head 38 through the ink circuit. The IC board 79 is located on the rear surface of the tank 34.

An image recording position is a position directly above the platen 104. At the image recording position, the head 38 is spaced apart from the platen 104 in the up-down direction (an example of a second direction) 7. The head 38 faces the platen 104 with the conveyance path 43 in between. The head 38 is connected to the tank 34 by an ink tube (not shown) in a fluid-communicable manner. The ink stored in the tank 34 is supplied to the head 38. At the image recording position, the head 38 is controlled by the controller 130 to discharge ink droplets downward from the nozzles 39 toward the sheet S.

The mounting case 110 is located in the vicinity of a front end and a lower end of the housing 30, and has a box shape that opens toward the front. The tank 34 is inserted rearward into the mounting case 110. The ink needle 112 extending forward is located on the rearward end surface 111 of the mounting case 110. The front end of the ink needle 112 is open, and the trailing end thereof is connected to the ink circuit (not shown). The ink circuit connects the internal space of the ink needle 112 and the head 38 so that the ink can flow therethrough. When the tank 34 is mounted in the mounting case 110, the ink needle 112 is inserted into the outlet of the tank 34. Accordingly, the ink stored in the tank 34 is supplied to the head 38 through the ink needle 112 and the ink circuit. The ink is a polymer-containing liquid such as latex ink or a polymer-free liquid such as dye. The contact point 114 is located on the end surface 111. The contact point 114 is electrically connected to the IC board 79 of the tank 34 in a state in which the tank 34 is mounted in the mounting case 110. The controller 130 can access the storage area of the IC board 79 through the contact point 114. The IC board 79 stores whether the liquid stored in the tank 34 is a polymer-containing liquid (an example of first information) or a polymer-free liquid (an example of second information), and can be read by the controller 130.

### Head 38

The head 38 has a rectangular parallelepiped shape elongated substantially in the left-right direction 9. The head 38 includes a frame 48 and the discharge module 49. The number of discharge modules 49 in the embodiment is one.

The discharge module 49 is supported by the frame 48. A lower surface of the discharge module 49 is exposed downward. The discharge module 49 is disposed in the conveyance path 43 in the left-right direction 9.

The head 38 has a frame 29 on its lower surface. The frame 29 is located below the front, rear, left, and right edges of the nozzle surface 50. In the up-down direction 7, the frame 29 is located between the sheet S conveyed on the platen 104 and the nozzle surface 50. The frame 29 protrudes downward from the nozzle surface 50 and forms a step with the nozzle surface 50. A trailing end E1 of a rear frame 29a located below a rear edge of the head 38 coincides with a trailing end of the head 38 when viewed in the up-down direction 7. A front end E2 of a front frame 29b located below a front edge of the head 38 coincides with a front end of the head 38.

The discharge module 49 includes the plurality of nozzles 39. Each nozzle 39 is opened in the nozzle surface 50 of the discharge module 49. The nozzle surface 50 is a surface extending in the front-rear direction 8 and the left-right direction 9. As described above, the ink is discharged downward from the plurality of nozzles 39 toward the sheet S supported by the conveyance belt 101 of the first support mechanism 51, and an image is recorded on the sheet S.

The head 38 moves in the up-down direction 7 to a recording position, a capped position, a wiped position, and an uncapped position. The recording position is a position of the head 38 when an image is recorded on the sheet S supported by the conveyance belt 101. The capped position is a position of the head 38 when the discharge module 49 is covered with the cap 62 of the maintenance mechanism 60. The capped position is a position above the recording position (a position farther from the first support mechanism 51 than the recording position). The wiped position is a position of the head 38 when the wiper blade 64 of the maintenance mechanism 60 wipes the nozzle surface 50 of the discharge module 49. The wiped position is a position above the capped position. The wiped position is fixed in the up-down direction 7 while the nozzle surface 50 is being wiped by the wiper blade 64. The uncapped position is a position of the head 38 when the head 38 is completely separated from the maintenance mechanism 60. The uncapped position is a position above the wiped position.

As shown in FIG. 2, the head 38 is moved by a ball screw 20. The ball screw 20 includes a screw shaft 20A and a nut member 20B. The screw shaft 20A is rotatably supported by the lower housing 32 around a shaft along the up-down direction 7. The screw shaft 20A is rotated by a driving force transmitted from a head motor 54 (see FIG. 4). The nut member 20B moves upward by forward rotation of the screw shaft 20A, and moves downward by reverse rotation of the screw shaft 20A. A configuration for moving the head 38 up and down is not limited to the configuration using the ball screw 20, and various known configurations can be adopted.

### Maintenance Mechanism 60

As shown in FIG. 2, the maintenance mechanism 60 includes a support base 61, a case 74, the wiper blade 64, a support portion 75, and the cap 62. The support base 61 has a box shape with an opening at the top. The support base 61 is provided with the rack 154. The rack 154 is located on a lower surface of a bottom wall of the support base 61. The rack 154 is located on the lower surface of the bottom wall of the support base 61 over the entire surface in the inclined direction 6. The rack 154 can mesh with the gear 105 of the first support mechanism 51. When the driving force of the first motor 55 is transmitted to the gear 105 via the gear 106 in a state in which the rack 154 and the gear 105 mesh with each other, the maintenance mechanism 60 slides in the inclined direction 6 along the upper surface of the first support mechanism 51 in the second posture. Similarly, the maintenance mechanism 60 slides in the front-rear direction 8 along the upper surface of the first support mechanism 51 in the first posture. The rack 154, the gears 105 and 106, and the first motor 55 relatively move the head and the support base along the first direction. A first speed V1 when the maintenance mechanism 60 moves from a maintenance position to a wiping position is a constant speed.

An encoder 82 (see FIG. 4) is disposed on the support base 61. The encoder 82 includes an encoder strip extending in the front-rear direction 8 in the first support mechanism 51 and an optical sensor mounted on the maintenance mechanism 60. The encoder strip has a pattern in which a light transmitting portion for transmitting light and a light blocking portion for blocking light are alternately arranged at equal pitches in the front-rear direction 8. The optical sensor detects the light transmitting portion and the light blocking portion to detect a pulse signal. The pulse signal is a signal corresponding to a position of the wiper blade 64 in the front-rear direction 8. The pulse signal is output to the controller 130. The controller 130 calculates the position and a speed of the wiper blade 64 in the front-rear direction 8 based on the received pulse signal.

The rack 154 can mesh with the gears 118 and 119 of the second support mechanism 52. When the driving force of the first motor 55 is transmitted to the gears 118 and 119 via the gear 120 in a state in which at least one of the rack 154 and the gears 118 and 119 is meshed with each other, the maintenance mechanism 60 slides in the inclined direction 6 along an upper surface of the second support mechanism 52.

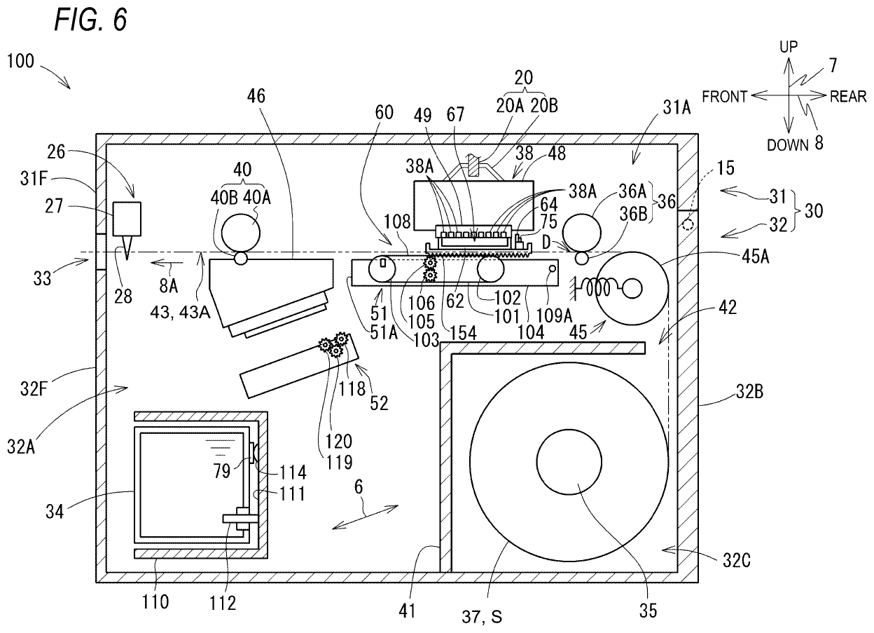

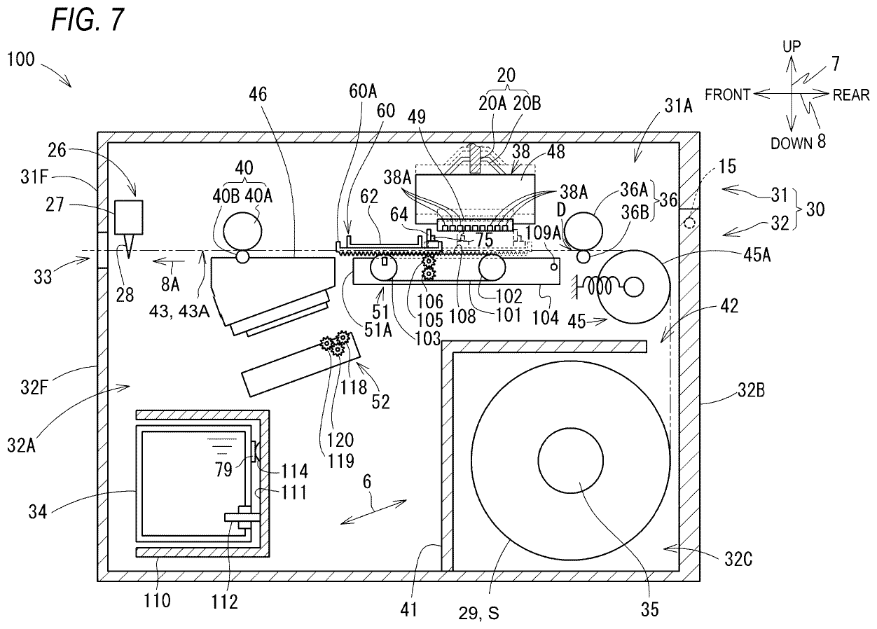

Accordingly, the maintenance mechanism 60 is located at a standby position where the maintenance mechanism 60 is located on the second support mechanism 52 as shown in FIG. 5, the maintenance position where the maintenance mechanism 60 is located on the first support mechanism 51 and directly below the nozzle surface 50 as shown in FIG. 6, and the wiping position where the maintenance mechanism 60 is located on the first support mechanism 51 as shown in FIG. 7. The maintenance mechanism 60 is movable to the wiping position in the wiping process.

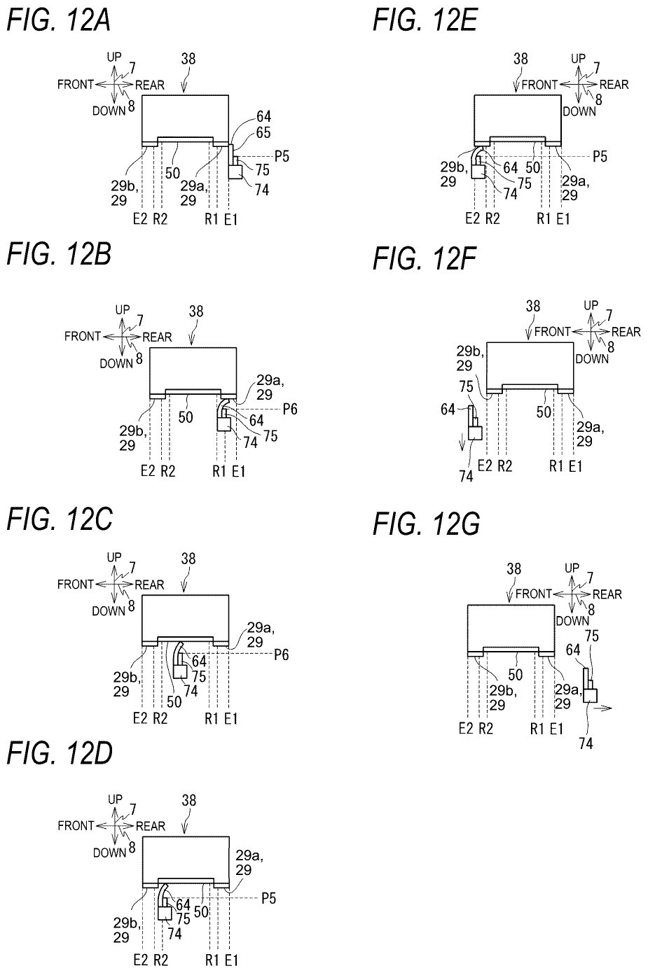

The case 74 is located behind the maintenance mechanism 60 and supports the wiper blade 64 and the support portion 75. The case 74 is made of synthetic resin and has a bottomed square tube shape. The case 74 can accommodate the support portion 75. The case 74 is located below the head 38 in the up-down direction 7. The case 74 is movable in the up-down direction 7 by a ball screw mechanism 88 (see FIG. 4). The case 74 is movable between an upper position (see FIG. 12A) where the wiper blade 64 is in contact with the nozzle surface 50 and a lower position (see FIG. 12F) where the wiper blade 64 is separated downward from the nozzle surface 50. The ball screw mechanism 88 is rotationally driven by a driving force transmitted from an up-down driving motor 92 (see FIG. 4). A configuration for moving the case 74 up and down is not limited to the configuration using the ball screw mechanism 88, and various known configurations can be adopted.

The wiper blade 64 is made of an elastic material such as rubber and has flexibility. The wiper blade 64 is fixed to the case 74. The wiper blade 64 has a rectangular parallelepiped shape. The wiper blade 64 is located on a front side of the case 74 and extends upward from the case 74 along the up-down direction 7. The wiper blade 64 is longer in the left-right direction 9 than in the front-rear direction 8. The wiper blade 64 is movable in the front-rear direction 8 (an example of the first direction) while being in contact with the nozzle surface 50. When the wiper blade 64 wipes the nozzle surface 50, a leading end portion of the wiper blade 64 is in contact with the nozzle surface 50.

The support portion 75 is made of a resin material or a metal material. The support portion 75 is supported so as to be able to protrude and retract from the case 74. A lower end of the support portion 75 is supported by a cam 87 (see FIG. 4), and the position of the support portion 75 is adjusted in the up-down direction by applying a rotational force to the cam 87. A surface of the support portion 75 facing forward is in contact with a surface of the wiper blade 64 facing rearward, and the support portion 75 slides against a rear surface 65 (see FIG. 12A) of the wiper blade 64 when moving in the up-down direction 7. When wiping the nozzle surface 50, the rear surface 65 of the wiper blade 64 is supported by the support portion 75, and the leading end portion of the wiper blade 64 is curved rearward. At this time, a pressing force is applied to the nozzle surface 50 by the wiper blade 64. The support portion 75 can detect a position in the up-down direction 7 by a position sensor 76 (see FIG. 4). The position sensor 76 has a plurality of protrusions 77 protruding forward from a main body 78 toward a track of the support portion 75. The plurality of protrusions 77 are supported forward by a coil spring, and are retracted rearward by the support portion 75 moving upward and coming into contact with the protrusions 77.

The cap 62 is supported by the support base 61. The cap 62 is located in front of the wiper blade 64 with an interval therebetween. The cap 62 has a box shape with an open top. The cap 62 is made of an elastic body such as rubber or silicon. The cap 62 can face the discharge module 49. When the maintenance mechanism 60 is located at the maintenance position, the cap 62 is in contact with the nozzle surface 50 to seal an internal space 67 of the cap 62. Accordingly, the cap 62 covers the plurality of nozzles 39. A tube (not shown) for discharging a waste liquid from the internal space 67 after the purge process and the flushing process is connected to the cap 62. The tube communicates with the internal space 67, and the pump 73 and a valve 83 are arranged in series in the tube.

### Controller 130

The controller 130 controls various operations of the image recording device 100. As shown in FIG. 4, the controller 130 includes a CPU 131 and an ASIC 135. A memory 140 includes a ROM 132, a RAM 133, an EEPROM 134, and a timer 136. The CPU 131, the ASIC 135, the ROM 132, the RAM 133, the EEPROM 134, and the timer 136 are connected via an internal bus 137.

The ROM 132 stores programs for controlling various operations of the CPU 131. The RAM 133 is used as a storage area for temporarily storing data, signals, and the like used when the CPU 131 executes the above programs, or a work area for data processing. The EEPROM 134 stores settings, flags, and the like to be held even after power is turned off. The timer 136 starts clocking in response to a command from the CPU 131, and returns an elapsed time to the CPU 131. The timer 136 may be an independent IC or may be incorporated in the CPU 131.

The conveyance motor 53, the head motor 54, the first motor 55, the second motor 56, an absorption pump motor 58, the shaft motor 59, a support portion driving motor 86, and the up-down driving motor 92 are connected to the ASIC 135. The valve 83 is connected to the ASIC 135. The valve 83 is connected to the ASIC 135 via a drive circuit for driving the valve 83.

The ASIC 135 generates driving signals for rotating the motors, and controls the motors based on the driving signals. Each motor rotates forward or backward according to the driving signals from the ASIC 135. The controller 130 controls driving of the conveyance motor 53 to rotate the holder 35, the conveyance roller 36A, the conveyance roller 40A, and the driving roller 102. The controller 130 controls driving of the head motor 54 to rotate the screw shaft 20A and move the head 38 in the up-down direction 7. The controller 130 controls driving of the shaft motor 59 to rotate the first support mechanism 51. The controller 130 controls driving of the first motor 55 to rotate the gear 106 of the first support mechanism 51. The controller 130 controls driving of the second motor 56 to rotate the gear 120 of the second support mechanism 52. The controller 130 controls driving of the support portion driving motor 86 to rotate the cam 87 that supports the support portion 75. A second speed V2 when the support portion 75 moves between the upper position and the lower position is a constant speed. The controller 130 controls driving of the absorption pump motor 58 to drive the pump 73. The controller 130 controls driving of a valve motor 57 to open and close the valve 83.

The operation panel 44, the display unit 44A, the contact point 114, the encoder 82, the valve 83, the position sensor 76, and the piezoelectric element are connected to the ASIC 35. The operation panel 44 outputs an operation signal corresponding to an operation by the user to the controller 130. The operation panel 44 may include, for example, a push button or a touch sensor superimposed on a display. The controller 130 reads identification information from the storage area of the IC board 79 of the tank 34 through the contact point 114. The controller 130 causes the display unit 44A to display that the tank 34 is mounted on the mounting case 110 based on the identification information. The position sensor 76 outputs a signal to the controller 130 in response to the rearward retraction of the protrusions 77. The piezoelectric element operates by being supplied with power from the controller 130 via a drive circuit (not shown). The controller 130 controls power supply to the piezoelectric element and causes the ink droplets to be selectively discharged from the plurality of nozzles 39.

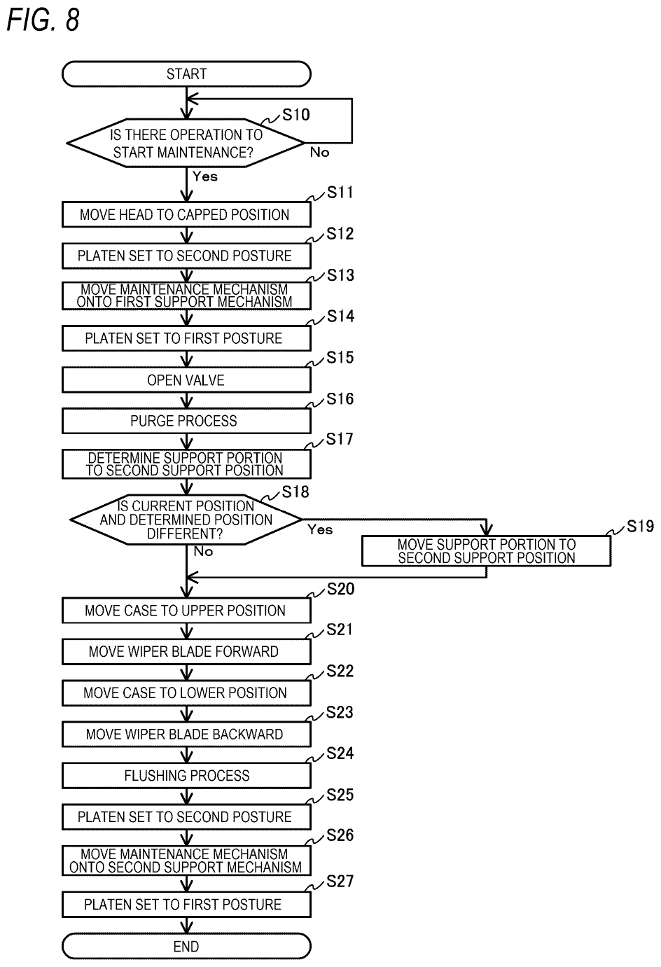

Next, control of the maintenance mechanism 60 performed by the controller 130 in maintenance of the head 38 will be described with reference to FIG. 8. In the maintenance, the purge process, the flushing process, and the wiping process are performed.

The maintenance is started when the user performs an operation to start the maintenance from the operation panel 44 during or before the image recording while the image recording device 100 is powered on. At this time, the maintenance mechanism 60 is located at the standby position (see FIG. 5), and the head 38 is located at the recording position. The platen 104 is in the first posture, and the case 74 is located at the lower position.

First, the controller 130 determines whether a maintenance start signal is received from the operation panel 44 (S10). When the maintenance start signal is not received (S10: No), the controller 130 continues the determination until the maintenance start signal is received. When it is determined that the maintenance start signal is received (S10: Yes), the controller 130 drives the head motor 54 (S11). When the head motor 54 is driven, the head 38 moves from the recording position to the capped position.

Next, the controller 130 drives the shaft motor 59 (S12). When the shaft motor 59 is driven, the platen 104 rotates counterclockwise about the shaft 109A and takes the second posture. The controller 130 drives the first motor 55 and the second motor 56 (S13). When the first motor 55 and the second motor 56 are driven, the maintenance mechanism 60 moves from above the second support mechanism 52 to above the first support mechanism 51. The controller 130 drives the shaft motor 59 (S14). When the shaft motor 59 is driven, the platen 104 rotates clockwise about the shaft 109A and takes the first posture. That is, the maintenance mechanism 60 is located at the maintenance position. At this time, the nozzle surface 50 is covered with the cap 62 (see FIG. 6).

The controller 130 opens the valve 83 (S15). When the valve 83 is opened, the internal space 67 communicates with the pump 73. In this state, the controller 130 drives the absorption pump motor 58 (S16). When the absorption pump motor 58 is driven, the pump 73 is started. When the pump 73 is started, the ink is absorbed from the plurality of nozzles 39 and the purge process is executed. At this time, a foreign matter is removed together with the ink from the nozzles 39.

The controller 130 determines a second support position P2 which is a position of the support portion 75 in the up-down direction 7 in the purge process (S17). Specifically, the controller 130 determines the position of the support portion 75 in the up-down direction 7 in the purge process from a table stored in the EEPROM 134 or the ROM 132. The controller 130 determines, based on an output signal of the position sensor 76, whether a position of the support portion 75 in the up-down direction 7 at the time of step S18 is different from the determined second support position P2 (S18). When it is determined that the current position of the support portion 75 is different from the second support position P2 (S18: Yes), the controller 130 drives the support portion driving motor 86 (S19). When the support portion driving motor 86 is driven, the cam 87 rotates, and the support portion 75 is moved to the second support position P2 at the second speed V2. The second speed V2 of the support portion 75 is higher than the first speed V1 of the maintenance mechanism 60. After moving the support portion 75 to the second support position P2 in step S19, or when it is determined that the current position of the support portion 75 is the same as the second support position P2 (S18: No), the controller 130 drives the up-down driving motor 92 (S20). When the up-down driving motor 92 is driven, the case 74 is moved to the upper position by the ball screw mechanism 88. At this time, an upper end of the wiper blade 64 is located above the nozzle surface 50.

The controller 130 drives the first motor 55 (S21). When the first motor 55 is driven, the maintenance mechanism 60 moves forward. The maintenance mechanism 60 moves forward from the maintenance position to the wiping position (see FIG. 7). When the maintenance mechanism 60 moves from the maintenance position to the wiping position, the position of the wiper blade 64 in the front-rear direction 8 is detected based on a signal from the encoder 82. The wiper blade 64 is in contact with the nozzle surface 50 in a state in which the rear surface 65 is supported by the support portion 75. The wiper blade 64 is curved rearward due to friction with the nozzle surface 50 and wipes the nozzle surface 50. When the forward movement of the maintenance mechanism 60 is completed, the controller 130 drives the up-down driving motor 92 (S22). When the up-down driving motor 92 is driven, the case 74 is moved to the lower position by the ball screw mechanism 88. At this time, the leading end of the wiper blade 64 is located below the nozzle surface 50. The controller 130 drives the first motor 55 (S23). When the first motor 55 is driven, the maintenance mechanism 60 moves rearward and is located at the maintenance position.

The controller 130 drives the piezoelectric element (S24). When the piezoelectric element is driven, the flushing process is performed in which the ink is discharged from the nozzles 39 toward the cap 62. By performing the flushing process, a meniscus is formed in the nozzle 39.

After the flushing process is performed, the controller 130 drives the shaft motor 59 (S25). When the shaft motor 59 is driven, the platen 104 rotates counterclockwise about the shaft 109A and takes the second posture. The controller 130 drives the first motor 55 and the second motor 56 (S26). When the first motor 55 and the second motor 56 are driven, the maintenance mechanism 60 moves from above the first support mechanism 51 to above the second support mechanism 52, and moves to the standby position. The controller 130 drives the shaft motor 59 (S27). When the shaft motor 59 is driven, the platen 104 rotates clockwise about the shaft 109A and takes the first posture. The maintenance is thus completed.

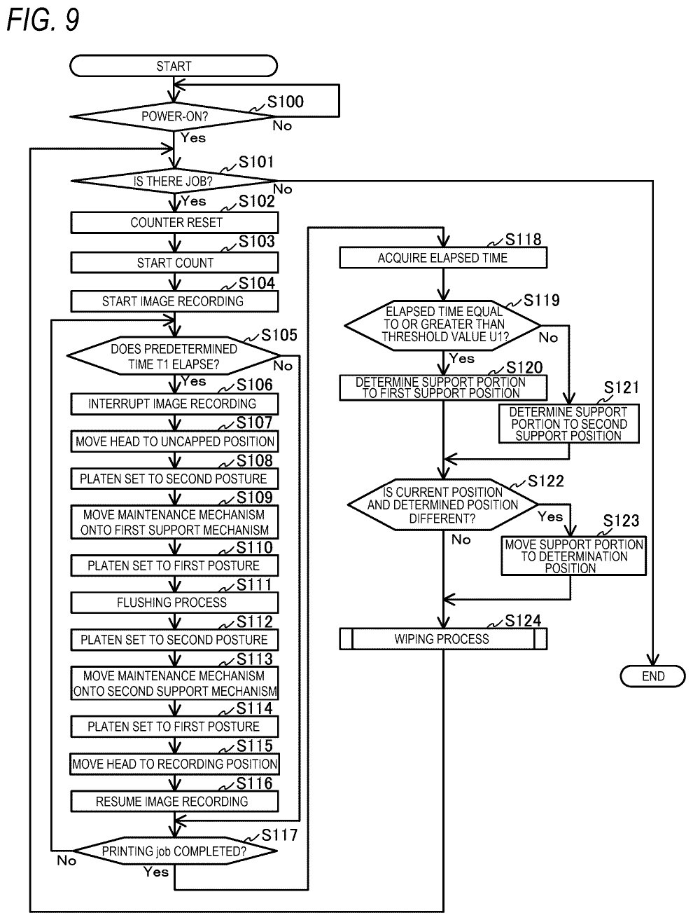

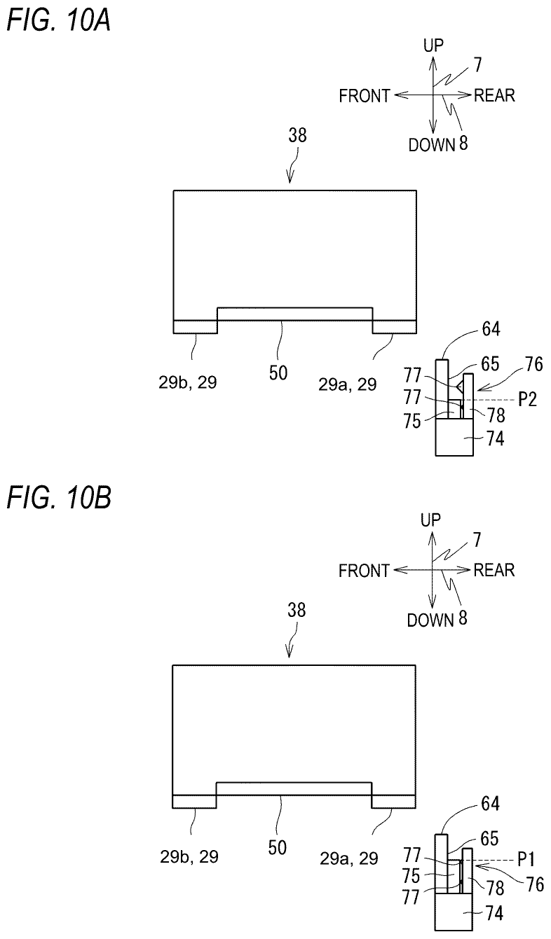

Next, the control of the maintenance mechanism 60 performed by the controller 130 based on an elapsed time from adhering of the ink to the nozzle surface 50 and presence or absence of a step of the nozzle surface 50 will be described with reference to FIGS. 9 and 10A and 10B. A timing at which the ink adheres to the nozzle surface 50 is when the ink is discharged from the nozzle 39. At the start of the control, the maintenance mechanism 60 is located at the standby position, and the head 38 is located at the recording position. The platen 104 is in the first posture, the case 74 is located at the lower position, and the tank 34 is mounted in the mounting case 110.

First, the controller 130 determines whether a signal for turning on the power of the image recording device 100 is received from the operation panel 44 (S100). When a power-on signal is not received (S100: No), the controller 130 continues the determination until the power-on signal is received. When it is determined that the power-on signal is received (S100: Yes), the controller 130 determines whether there is a job to be printed in the image recording device 100 (S101). When it is determined that there is no job to be printed (S101: No), the controller 130 ends the control of the image recording device 100. When it is determined that there is a job to be printed (S101: Yes), the controller 130 resets a count of the timer 136 (S102). The controller 130 causes the timer 136 to start counting (S103). The counting is started at a timing at which the ink starts to be discharged from the head 38.

The controller 130 drives the conveyance motor 53 and the piezoelectric element (S104). When the piezoelectric element is driven together with the conveyance motor 53, the ink is discharged from the nozzles 39 and an image is recorded on the conveyed sheet S. The controller 130 determines whether a predetermined time T1 elapses from the start of counting (S105). Here, the predetermined time T1 is a time set in advance and stored in the ROM 132 or the EEPROM 134, and is a time from the start of the discharge of the ink to the start of the flushing process. When it is determined that the predetermined time T1 does not elapse (S105: No), the controller 130 determines whether a print job is completed (S117). Step S117 and subsequent steps will be described later. When it is determined that the predetermined time T1 elapses (S105: Yes), the controller 130 interrupts driving of the conveyance motor 53 and the piezoelectric element (S106). When the driving of the conveyance motor 53 and the piezoelectric element is interrupted, the image recording is interrupted.

The controller 130 drives the head motor 54 (S107). When the head motor 54 is driven, the head 38 moves from the recording position to the uncapped position (see a broken line in FIG. 7). The controller 130 drives the shaft motor 59 (S108). When the shaft motor 59 is driven, the platen 104 rotates counterclockwise about the shaft 109A and takes the second posture. The controller 130 drives the first motor 55 and the second motor 56 (S109). When the first motor 55 and the second motor 56 are driven, the maintenance mechanism 60 moves from above the second support mechanism 52 to above the first support mechanism 51. The controller 130 drives the shaft motor 59 (S110). When the shaft motor 59 is driven, the platen 104 rotates clockwise about the shaft 109A to the first posture, and the maintenance mechanism 60 is located at the maintenance position. At this time, the cap 62 is separated from the nozzle surface 50.

The controller 130 drives the piezoelectric element (S111). When the piezoelectric element is driven, the flushing process is performed in which the ink is discharged from the nozzles 39 toward the cap 62. After the flushing process is performed, the controller 130 drives the shaft motor 59 (S112). When the shaft motor 59 is driven, the platen 104 rotates counterclockwise about the shaft 109A and takes the second posture. The controller 130 drives the first motor 55 and the second motor 56 (S113). When the first motor 55 and the second motor 56 are driven, the maintenance mechanism 60 moves from above the first support mechanism 51 to above the second support mechanism 52, and moves to the standby position (see FIG. 5). The controller 130 drives the shaft motor 59 (S114). When the shaft motor 59 is driven, the platen 104 rotates clockwise about the shaft 109A and takes the first posture.

The controller 130 drives the head motor 54 (S115). When the head motor 54 is driven, the head 38 moves from the uncapped position to the recording position. The controller 130 drives the conveyance motor 53 and the piezoelectric element (S116). When the piezoelectric element is driven together with the conveyance motor 53, the ink is discharged from the nozzle 39 and the image recording on the conveyed sheet S is resumed. The controller 130 determines whether the print job is completed (S117). When it is determined that the print job is not completed (S117: No), the controller 130 again determines whether the predetermined time T1 elapses (S105), and repeats the above-described steps.

When it is determined that the print job is completed (S117: Yes), the controller 130 acquires from the timer 136 the elapsed time from the start of the counting to the time when the print job is completed (S118). The controller 130 determines whether the acquired elapsed time is equal to or greater than a threshold value U1 (S119). The threshold value U1 is a value set in advance and stored in the ROM 132 or the EEPROM 134. The threshold value U1 is set in consideration of, for example, a time from exposure of the ink to outside air to the start of curing. When it is determined that the acquired elapsed time is less than the threshold value U1 (S119: No), the controller 130 determines the second support position P2 of the support portion 75 in the up-down direction 7 (S121). The controller 130 determines the position of the support portion 75 in the up-down direction 7 when the threshold value is less than U1 from the table stored in the EEPROM 134 or the ROM 132.

When it is determined that the acquired elapsed time is equal to or greater than the threshold value U1 (S119: Yes), the controller 130 determines the first support position P1 of the support portion 75 in the up-down direction 7 (S120). The controller 130 determines the position of the support portion 75 in the up-down direction 7 based on the threshold value U1 from the table stored in the EEPROM 134 or the ROM 132. As shown in FIGS. 10A and 10B, an upper end of the support portion 75 at the first support position P1 is located above the upper end of the support portion 75 at the second support position P2. That is, since the first support position P1 is closer to the nozzle surface 50 than the second support position P2, the pressing force of the wiper blade 64 against the nozzle surface 50 is increased. The controller 130 determines, based on the output signal of the position sensor 76, whether a current position of the support portion 75 in the up-down direction 7 is different from the first support position P1 determined in step S120 or different from the second support position P2 determined in step 121 (S122). When it is determined that the position of the support portion 75 at the time of step S122 is different from the first support position P1 determined in step S120 or different from the second support position P2 determined in step S121 (S122: Yes), the controller 130 drives the support portion driving motor 86 to move the support portion 75 to the first support position P1 or the second support position P2 (S123). The controller 130 performs the wiping process (S124) after moving the support portion 75 to the first support position P1 or to the second support position P2 in step S123. When it is determined that the current position of the support portion 75 is the same as the first support position P1 or the current position of the support portion 75 is the same as the second support position P2 (S122: No), the controller 130 performs the wiping process (S124).

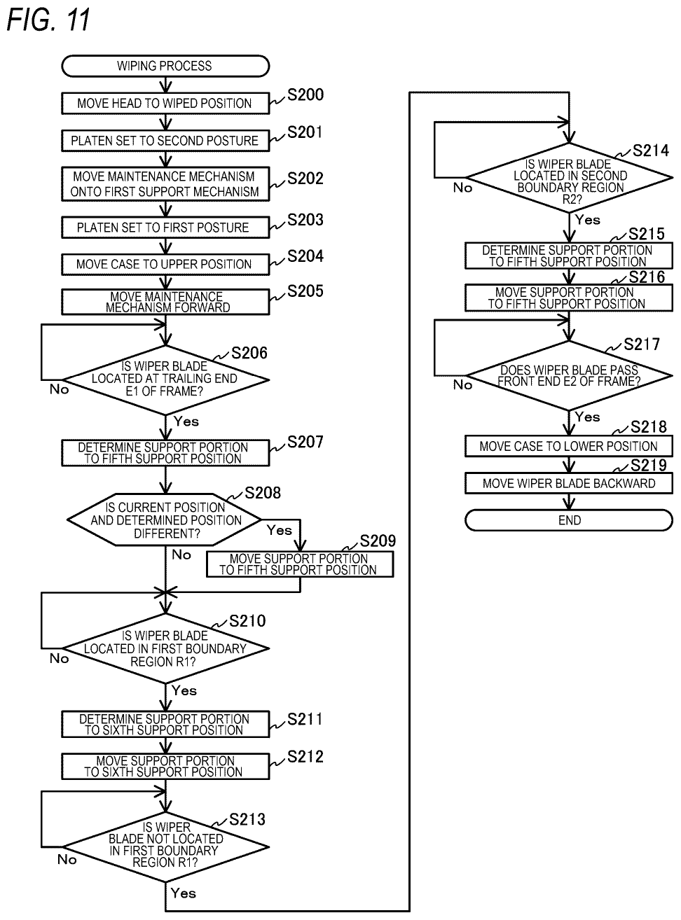

Next, the wiping process will be described with reference to FIGS. 11 and 12A to 12G. In the wiping process, the controller 130 controls the maintenance mechanism 60 in accordance with the step of the nozzle surface 50. At the start of the wiping process, the maintenance mechanism 60 is located at the standby position, and the head 38 is located at the recording position. The platen 104 is in the first posture, and the case 74 is located at the lower position. In FIGS. 12A to 12G, the description of the position sensor 76 is omitted.

In the wiping process, first, the controller 130 drives the head motor 54 (S200). When the head motor 54 is driven, the head 38 moves from the recording position to the wiped position (see FIG. 7). Next, the controller 130 drives the shaft motor 59 (S201). When the shaft motor 59 is driven, the platen 104 rotates counterclockwise about the shaft 109A and takes the second posture (see FIG. 5). The controller 130 drives the first motor 55 and the second motor 56 (S202). When the first motor 55 and the second motor 56 are driven, the maintenance mechanism 60 moves from above the second support mechanism 52 to above the first support mechanism 51. The controller 130 drives the shaft motor 59 (S203). When the shaft motor 59 is driven, the platen 104 rotates clockwise about the shaft 109A to the first posture, and the maintenance mechanism 60 is located at the maintenance position.

The controller 130 drives the up-down driving motor 92 (S204). When the up-down driving motor 92 is driven, the case 74 is moved to the upper position by the ball screw mechanism 88. At this time, the upper end of the wiper blade 64 is located above the nozzle surface 50 as shown in FIG. 12A.

The controller 130 drives the first motor 55 (S205). When the first motor 55 is driven, the maintenance mechanism 60 moves forward. When the maintenance mechanism 60 moves from the maintenance position to the wiping position, the position of the wiper blade 64 in the front-rear direction 8 is detected based on a signal from the encoder 82.

The controller 130 determines whether the wiper blade 64 is located at the trailing end E1 of the rear frame 29a (see FIGS. 12A to 12G) (S206). When it is determined that the wiper blade 64 is not located at the trailing end E1 (S206: No), the controller 130 continues the determination until the wiper blade 64 is located at the trailing end E1. When it is determined that the wiper blade 64 is located at the trailing end E1 (S206: Yes), the controller 130 determines a fifth support position P5 which is a position of the support portion 75 in the up-down direction 7 when wiping the rear frame 29a (S207). The fifth support position P5 is a position set in advance and stored in the ROM 132 or the EEPROM 134.

The controller 130 determines, based on the output signal of the position sensor 76, whether the current position of the support portion 75 in the up-down direction 7 is different from the fifth support position P5 determined in step S207 (S208). When it is determined that the position of the support portion 75 at the time of step S208 is different from the fifth support position P5 (S208: Yes), the controller 130 drives the support portion driving motor 86 (S209). When the support portion driving motor 86 is driven, the cam 87 rotates, and the support portion 75 is moved to the fifth support position P5. After moving the support portion 75 to the fifth support position P5 in step S209, or when it is determined that the position of the support portion 75 at the time of step S208 is the same as the fifth support position P5 (S208: No), the controller 130 determines whether the wiper blade 64 is located in a first boundary region R1 based on an output signal of the encoder 82 (S210).

As shown in FIG. 12B, the first boundary region R1 is a region having a predetermined width in the front-rear direction 8, and a center of the first boundary region R1 is a boundary between the rear frame 29a located behind the head 38 and the nozzle surface 50 in the front-rear direction 8. A step recessed upward is formed from the rear frame 29a to the nozzle surface 50.

When it is determined that the wiper blade 64 is not located in the first boundary region R1 in the front-rear direction 8 (S210: No), the controller 130 continues the determination until the wiper blade 64 is located in the first boundary region R1. As shown in FIG. 12B, when it is determined that the wiper blade 64 is located in the first boundary region R1 (S210: Yes), the controller 130 determines a sixth support position P6 of the support portion 75 (S211). The sixth support position P6 is a position set in advance and stored in the ROM 132 or the EEPROM 134. The controller 130 drives the support portion driving motor 86 (S212). When the support portion driving motor 86 is driven, the cam 87 rotates, and the support portion 75 is moved to the sixth support position P6.

The controller 130 determines whether the wiper blade 64 is not located in the first boundary region R1 in the front-rear direction 8 (S213). When it is determined that the wiper blade 64 is located in the first boundary region R1 (S213: No), the controller 130 continues the determination until the wiper blade 64 is no longer located in the first boundary region R1. As shown in FIG. 12C, when it is determined that the wiper blade 64 is not located in the first boundary region R1 (S213: Yes), the controller 130 determines whether the wiper blade 64 is located in a second boundary region R2 based on the output signal of the encoder 82 (S214). As shown in FIG. 12D, the second boundary region R2 is a region having a predetermined width in the front-rear direction 8, and a center of the second boundary region R2 is a boundary between the front frame 29b located at the front of the head 38 and the nozzle surface 50 in the front-rear direction 8. A step protruding downward is formed from the nozzle surface 50 to the front frame 29b. When it is determined that the wiper blade 64 is not located in the second boundary region R2 (S214: No), the controller 130 continues the determination until the wiper blade 64 is located in the second boundary region R2.

As shown in FIG. 12D, when it is determined that the wiper blade 64 is located in the second boundary region R2 (S214: Yes), the controller 130 determines the fifth support position P5 of the support portion 75 (S215). The controller 130 drives the support portion driving motor 86 (S216). When the support portion driving motor 86 is driven, the cam 87 rotates, and the support portion 75 is moved to the fifth support position P5.

The controller 130 determines whether the wiper blade 64 passes the front end E2 (see FIGS. 12A to 12G) based on the output signal of the encoder 82 (S217). When it is determined that the wiper blade 64 does not pass the front end E2 (S217: No), the controller 130 continues the determination until the wiper blade 64 passes the front end E2 (see FIG. 12E). As shown in FIG. 12F, when it is determined that the wiper blade 64 passes the front end E2 (S217: Yes), the controller 130 drives the up-down driving motor 92 (S218). When the up-down driving motor 92 is driven, the case 74 is moved to the lower position by the ball screw mechanism 88 as indicated by an arrow in FIG. 12F. At this time, the upper end of the wiper blade 64 is located below the nozzle surface 50. The controller 130 drives the first motor 55 (S218). When the first motor 55 is driven, the maintenance mechanism 60 moves rearward, as shown in FIG. 12G. The maintenance mechanism 60 moves from the wiping position to the maintenance position by moving rearward, and the wiping process is completed.

### Operation and Effect of Embodiment

The controller 130 determines the position of the support portion 75 in the up-down direction 7 as the first support position P1 based on the fact that the elapsed time from the discharge of the ink is equal to or greater than the preset threshold value U1. Depending on the position of the support portion 75, a deformation amount of the wiper blade 64 when wiping the nozzle surface 50 changes. The pressing force of the wiper blade 64 against the nozzle surface 50 changes depending on the deformation amount of the wiper blade 64. The ink adhering to the nozzle surface 50 is solidified according to the elapsed time. The pressing force of the wiper blade 64 against the nozzle surface 50 is set in advance to an appropriate pressing force according to the elapsed time for the ink to solidify, without the need to repeat the process of performing user cleaning. Therefore, a time required for the image recording and consumption of the sheet S and the ink can be reduced.

When the maintenance mechanism 60 moves from the maintenance position to the wiping position, the support portion 75 moves in a state in which a distance between the platen 104 and the nozzle surface 50 is constant, and the pressing force of the wiper blade 64 is determined only by the position of the support portion 75. Therefore, the pressing force of the wiper blade 64 against the nozzle surface 50 can be adjusted with high reproducibility.

The support portion 75 is closer to the nozzle surface 50 at the first support position P1 than at the second support position P2. Therefore, the pressing force of the wiper blade 64 against the nozzle surface 50 is larger at the end of image recording than at the end of purge. Since the ink is more likely to be solidified at the end of image recording than at the end of purge, the solidified ink can be wiped with a stronger pressing force.

When the wiper blade 64 is located in the first boundary region R1, the controller 130 positions the support portion 75 at the sixth support position P6. When the wiper blade 64 is further moved forward and no longer located in the first boundary region R1, the controller 130 positions the support portion 75 at the fifth support position P5. That is, the pressing force of the wiper blade 64 is appropriately adjusted with respect to the front frame 29b when the wiper blade 64 approaches the front frame 29b from the nozzle surface 50. Therefore, when the wiper blade 64 moves from the nozzle surface 50 to the front frame 29b, deterioration of the wiper blade 64 due to contact with the front frame 29b is reduced. In addition, the wiper blade 64 that wipes the nozzle surface 50 and absorbs the ink is prevented from coming into contact with the front frame 29b and causing the ink to scatter. The same applies to the movement from the fifth support position P5 to the sixth support position P6 when the wiper blade 64 moves from the rear frame 29a to the nozzle surface 50.

### Modification 1

In the embodiment described above, the case in which the controller 130 controls the maintenance mechanism 60 based on the elapsed time after the ink adheres to the nozzle surface 50 and the presence or absence of the step of the nozzle surface 50 is described as an example. However, the control of the image recording device 100 by the controller 130 is not limited to these conditions. The control of the maintenance position 60 by the controller 130 may be performed based on the liquid type information. In Modification 1, a case in which the liquid stored in the tank 34 is latex ink that is a polymer-containing liquid or a case in which the liquid stored in the tank 34 is a dye that is a polymer-free liquid will be described. In the image recording device 100 according to Modification 1, a case in which the head 38 does not have the frame 29 will be described as an example. The control of the maintenance mechanism 60 by the controller 130 does not take into consideration the elapsed time after the ink adheres to the nozzle surface 50 and the presence or absence of the step of the nozzle surface 50.

At the start of the control, the maintenance mechanism 60 is located at the standby position, and the head 38 is located at the recording position. The platen 104 is in the first posture, and the case 74 is located at the lower position.

In the control of the maintenance mechanism 60 based on the liquid type information, first, the controller 130 determines whether a signal for turning on the power of the image recording device 100 is received from the operation panel 44 (S300). When the power-on signal is not received (S300: No), the controller 130 continues the determination until the power-on signal is received. When it is determined that the power-on signal is received (S300: Yes), the controller 130 acquires the liquid type information from the IC board 79 (S301).

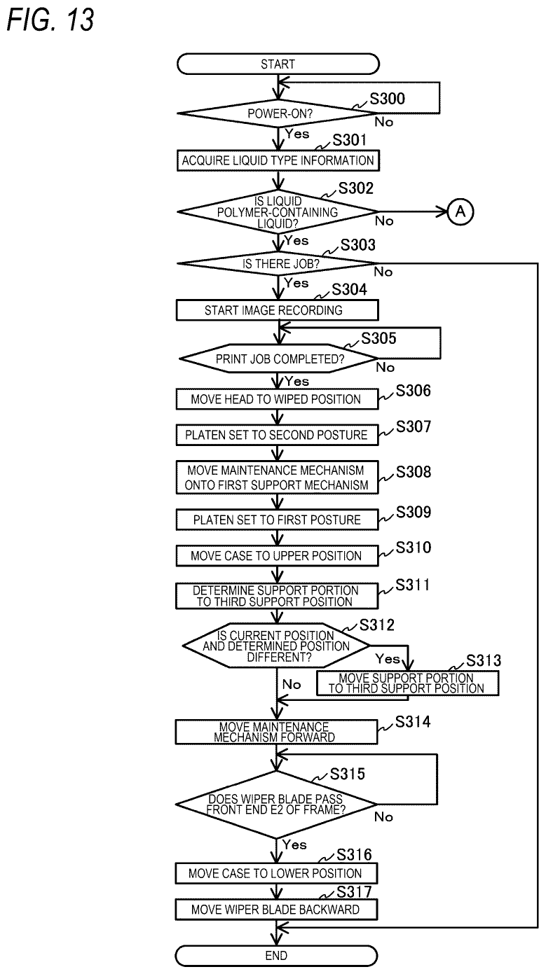

Next, the controller 130 determines whether the liquid type information is the polymer-containing liquid (S302). A case in which the controller 130 determines that the liquid type information is not the polymer-containing liquid (S302: No) will be described later (indicated by A in FIG. 13). When it is determined that the liquid type information is the polymer-containing liquid such as latex ink (S302: Yes), the controller 130 determines whether there is a job to be printed in the image recording device 100 (S303). When it is determined that there is no job to be printed (S303: No), the controller 130 ends the control of the image recording device 100.

When it is determined that there is a job to be printed (S303: Yes), the controller 130 drives the conveyance motor 53 and the piezoelectric element (S304). When the piezoelectric element is driven together with the conveyance motor 53, the ink is discharged from the nozzles 39 and an image is recorded on the conveyed sheet S. The controller 130 determines whether the print job is completed (S305). When it is determined that the print job is not completed (S305: No), the controller 130 continues the image recording until the print job is completed. When it is determined that the print job is completed (S305: Yes), the controller 130 drives the head motor 54 (S306). When the head motor 54 is driven, the head 38 moves from the recording position to the wiped position (indicated by a solid line in FIG. 7).

The controller 130 drives the shaft motor 59 (S307). When the shaft motor 59 is driven, the platen 104 rotates counterclockwise about the shaft 109A and takes the second posture. The controller 130 drives the first motor 55 and the second motor 56 (S308). When the first motor 55 and the second motor 56 are driven, the maintenance mechanism 60 moves from above the second support mechanism 52 to above the first support mechanism 51. The controller 130 drives the shaft motor 59 (S309). When the shaft motor 59 is driven, the platen 104 rotates clockwise about the shaft 109A to the first posture, and the maintenance mechanism 60 is located at the maintenance position. At this time, the cap 62 is separated from the nozzle surface 50. The controller 130 drives the up-down driving motor 92 (S310). When the up-down driving motor 92 is driven, the case 74 is moved to the upper position by the ball screw mechanism 88. At this time, the upper end of the wiper blade 64 is located above the nozzle surface 50.

The controller 130 determines a third support position P3 which is a position of the support portion 75 in the up-down direction 7 (S311). The third support position P3 is a position that is set in advance based on the fact that the liquid type information is the latex ink and is stored in the ROM 132 or the EEPROM 134.

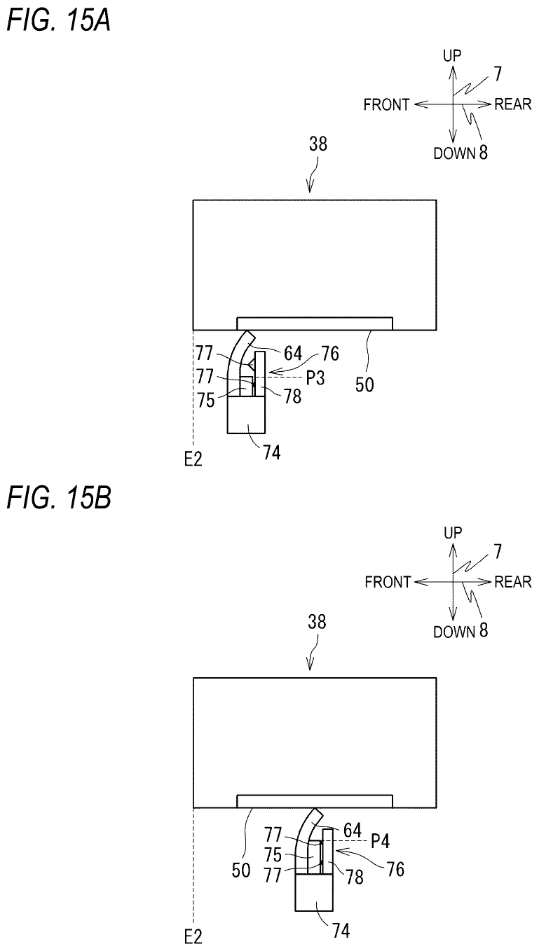

The controller 130 determines, based on the output signal of the position sensor 76, whether the position of the support portion 75 in the up-down direction 7 at the time of step S312 is different from the third support position P3 (S312). When it is determined that the position of the support portion 75 at the time of step S312 is different from the third support position P3 (S312: Yes), the controller 130 drives the support portion driving motor 86 (S313). When the support portion driving motor 86 is driven, the cam 87 rotates, and the support portion 75 is moved to the third support position P3 shown in FIG. 15A. After moving the support portion 75 to the third support position P3 in step S313, or when it is determined that the position of the support portion 75 at the time of step S312 is the same as the third support position P3 (S312: No), the controller 130 drives the first motor 55 (S314). When the first motor 55 is driven, the maintenance mechanism 60 moves forward.

The controller 130 determines whether the wiper blade 64 passes the front end E2 based on the output signal of the encoder 82 (S315). When it is determined that the wiper blade 64 does not pass the front end E2 (S315: No), the controller 130 continues the determination until the wiper blade 64 passes the front end E2. When it is determined that the wiper blade 64 passes the front end E2 (S315: Yes), the controller 130 drives the up-down driving motor 92 (S316). When the up-down driving motor 92 is driven, the case 74 is moved to the lower position by the ball screw mechanism 88. At this time, the upper end of the wiper blade 64 is located below the nozzle surface 50.

The controller 130 drives the first motor 55 (S317). When the first motor 55 is driven, the maintenance mechanism 60 moves rearward. The maintenance mechanism 60 moves from the wiping position to the maintenance position by moving rearward, and the wiping process is completed.

Next, in step S302, the case in which the controller 130 determines that the liquid type information is not the polymer-containing liquid (S302: No) will be described. First, when it is determined that the liquid type information is a polymer-containing liquid such as a dye (S302: No), the controller 130 determines whether there is a job to be printed in the image recording device 100 (S400). When it is determined that there is no job to be printed (S400: No), the controller 130 ends the control of the image recording device 100.

When it is determined that there is a job to be printed (S400: Yes), the controller 130 drives the conveyance motor 53 and the piezoelectric element (S402). When the piezoelectric element is driven together with the conveyance motor 53, the ink is discharged from the nozzles 39 and an image is recorded on the conveyed sheet S. The controller 130 determines whether the print job is completed (S402). When it is determined that the print job is not completed (S402: No), the controller 130 continues the image recording until the print job is completed. When it is determined that the print job is completed (S402: Yes), the controller 130 drives the head motor 54 (S403). When the head motor 54 is driven, the head 38 moves from the recording position to the wiped position.

The controller 130 drives the shaft motor 59 (S404). When the shaft motor 59 is driven, the platen 104 rotates counterclockwise about the shaft 109A and takes the second posture. The controller 130 drives the first motor 55 and the second motor 56 (S405). When the first motor 55 and the second motor 56 are driven, the maintenance mechanism 60 moves from above the second support mechanism 52 to above the first support mechanism 51. The controller 130 drives the shaft motor 59 (S406). When the shaft motor 59 is driven, the platen 104 rotates clockwise about the shaft 109A to the first posture, and the maintenance mechanism 60 is located at the maintenance position. The controller 130 drives the up-down driving motor 92 (S407). When the up-down driving motor 92 is driven, the case 74 is moved to the upper position by the ball screw mechanism 88.

The controller 130 determines a fourth support position P4 which is a position of the support portion 75 in the up-down direction 7 (S408). The fourth support position P4 is a position that is set in advance based on the fact that the liquid type information is the dye and is stored in the ROM 132 or the EEPROM 134.

The controller 130 determines, based on the output signal of the position sensor 76, whether the position of the support portion 75 in the up-down direction 7 at the time of step S409 is different from the fourth support position P4 (S409). When it is determined that the position of the support portion 75 is different from the fourth support position P4 at the time of step S409 (S409: Yes), the controller 130 drives the support portion driving motor 86 (S410). When the support portion driving motor 86 is driven, the cam 87 rotates, and the support portion 75 is moved to the fourth support position P4 shown in FIG. 15B. As shown in FIGS. 15A and 15B, the fourth support position P4 is located above the third support position P3. After moving the support portion 75 to the fourth support position P4 in step S410, or when it is determined that the position of the support portion 75 at the time of step S409 is the same as the fourth support position P4 (S409: No), the controller 130 drives the first motor 55 (S411). When the first motor 55 is driven, the maintenance mechanism 60 moves forward.

The controller 130 determines whether the wiper blade 64 passes the front end E2 based on the output signal of the encoder 82 (S412). When it is determined that the wiper blade 64 does not pass the front end E2 (S412: No), the controller 130 continues the determination until the wiper blade 64 passes the front end E2. When it is determined that the wiper blade 64 passes the front end E2 (S412: Yes), the controller 130 drives the up-down driving motor 92 (S413). When the up-down driving motor 92 is driven, the case 74 is moved to the lower position by the ball screw mechanism 88.

The controller 130 drives the first motor 55 (S414). When the first motor 55 is driven, the maintenance mechanism 60 moves rearward. The maintenance mechanism 60 moves from the wiping position to the maintenance position by moving rearward, and the wiping process is completed.

### Operation and Effect of Modification 1

The controller 130 can determine the position of the support portion 75 based on the liquid type information in addition to the elapsed time. Therefore, even when the pressing force of the wiper blade 64 against the nozzle surface 50 is made stronger as the ink solidifies after a predetermined time elapses from the start of image recording, the pressing force against the nozzle surface 50 can be set even stronger in response to ease of solidification of the ink.

The controller 130 can also perform the determination based on the liquid type information in addition to the elapsed time from the ink discharge and the position of the wiper blade 64 with respect to the first boundary region R1 and the second boundary region R2. The controller 130 can increase the pressing force in a stepwise manner according to the elapsed time from the start of the image recording and the ease of solidification of the ink, and can further adjust the pressing force even if there is a step when wiping. Therefore, it is possible to reliably wipe the ink adhesion to the nozzle surface 50, and it is possible to prevent the wiper blade 64 from coming into contact with the front frame 29b and causing deterioration when moving from the nozzle surface 50 to the front frame 29b, and to prevent the ink from scattering. The same applies to the movement from the rear frame 29a to the nozzle surface 50.

In Modification 1, the case in which the head 38 does not have the frame 29, and the elapsed time from when the ink adheres to the nozzle surface 50 and the presence or absence of the step of the nozzle surface 50 are not the control conditions is described as an example. However, in the image recording device 100 according to Modification 1, in addition to the liquid type information, the maintenance mechanism 60 may be controlled based on the elapsed time after the ink adheres to the nozzle surface 50 and the presence or absence of the step of the nozzle surface 50, and the head 38 may have the frame 29.

### Modification 2

In the above-described embodiment, the case in which the support portion 75 is located at the second support position P2 after the purge process is performed in the maintenance is described, and when the purge process is performed after image recording, a stronger pressing force may be used to reliably wipe the adhered ink. For example, the nozzle surface 50 may be wiped by setting the support portion 75 to the fourth support position P4 located above the second support position P2. The control of the maintenance mechanism 60 by the controller 130 is specifically as follows.

At the start of the control, the maintenance mechanism 60 is located at the standby position, and the head 38 is located at the recording position. The platen 104 is in the first posture, and the case 74 is located at the lower position. The tank 34 in which latex ink is stored is mounted in the mounting case 110.

First, the controller 130 determines whether a signal for turning on the power of the image recording device 100 is received from the operation panel 44 (S500). When the power-on signal is not received (S500: No), the controller 130 continues the determination until the power-on signal is received. When it is determined that the power-on signal is received (S500: Yes), the controller 130 determines whether there is a job to be printed in the image recording device 100 (S501). When it is determined that there is no job to be printed (S501: No), the controller 130 ends the control of the image recording device 100.

When it is determined that there is a job to be printed (S501: Yes), the controller 130 drives the conveyance motor 53 and the piezoelectric element (S502). When the piezoelectric element is driven together with the conveyance motor 53, the ink is discharged from the nozzles 39 and an image is recorded on the conveyed sheet S. The controller 130 determines whether a purge process start signal is received from the operation panel 44 (S503). When the purge process start signal is not received (S503: No), the controller 130 determines whether a print job is completed (S524). When it is determined that the purge process start signal is received (S503: Yes), the controller 130 interrupts driving of the conveyance motor 53 and the piezoelectric element (S504). When the driving of the conveyance motor 53 and the piezoelectric element is interrupted, the image recording is interrupted.

The controller 130 drives the head motor 54 (S505). When the head motor 54 is driven, the head 38 moves from the recording position to the capped position. The controller 130 drives the shaft motor 59 (S506). When the shaft motor 59 is driven, the platen 104 rotates counterclockwise about the shaft 109A and takes the second posture. The controller 130 drives the first motor 55 and the second motor 56 (S507). When the first motor 55 and the second motor 56 are driven, the maintenance mechanism 60 moves from above the second support mechanism 52 to above the first support mechanism 51. The controller 130 drives the shaft motor 59 (S508). When the shaft motor 59 is driven, the platen 104 rotates clockwise about the shaft 109A and takes the first posture. The maintenance mechanism 60 is located at the maintenance position. At this time, the nozzle surface 50 is covered with the cap 62 (see FIG. 6).

The controller 130 opens the valve 83 (S509). When the valve 83 is opened, the internal space 67 communicates with the pump 73. In this state, the controller 130 drives the absorption pump motor 58 (S510). When the absorption pump motor 58 is driven, the pump 73 is started. When the pump 73 is started, the ink is absorbed from the plurality of nozzles 39 and the purge process is executed. At this time, a foreign matter is removed together with the ink from the nozzles 39.

The controller 130 determines the fourth support position P4 which is a position of the support portion 75 in the up-down direction 7 (S511). Specifically, the controller 130 determines the position of the support portion 75 in the up-down direction 7 from a table stored in the EEPROM 134 or the ROM 132 based on the fact that the purge process is performed during image recording. The fourth support position P4 is located above the second support position P2. The controller 130 determines, based on the output signal of the position sensor 76, whether the position of the support portion 75 in the up-down direction 7 at the time of step S512 is different from the fourth support position P4 determined in step S511 (S512). When it is determined that the position of the support portion 75 at the time of step 512 is different from the fourth support position P4 (S512: Yes), the controller 130 drives the support portion driving motor 86 (S513). When the support portion driving motor 86 is driven, the cam 87 rotates, and the support portion 75 is moved to the fourth support position P4. After moving the support portion 75 to the fourth support position P4 in step S513, or when it is determined that the position of the support portion 75 at the time of step 512 is the same as the fourth support position P4 (S512: No), the controller 130 drives the up-down driving motor 92 (S514). When the up-down driving motor 92 is driven, the case 74 is moved to the upper position by the ball screw mechanism 88. At this time, the upper end of the wiper blade 64 is located above the nozzle surface 50.

The controller 130 drives the first motor 55 (S515). When the first motor 55 is driven, the maintenance mechanism 60 moves forward. The maintenance mechanism 60 moves forward from the maintenance position to the wiping position (see FIG. 7). The controller 130 drives the up-down driving motor 92 (S516). When the up-down driving motor 92 is driven, the case 74 is moved to the lower position by the ball screw mechanism 88. At this time, the leading end of the wiper blade 64 is located below the nozzle surface 50. The controller 130 drives the first motor 55 (S517). When the first motor 55 is driven, the maintenance mechanism 60 moves rearward and is located at the maintenance position.

The controller 130 drives the piezoelectric element (S518). When the piezoelectric element is driven, the flushing process is performed in which the ink is discharged from the nozzles 39 toward the cap 62. By performing the flushing process, a meniscus is formed in the nozzle 39.

After the flushing process is performed, the controller 130 drives the shaft motor 59 (S519). When the shaft motor 59 is driven, the platen 104 rotates counterclockwise about the shaft 109A and takes the second posture. The controller 130 drives the first motor 55 and the second motor 56 (S520). When the first motor 55 and the second motor 56 are driven, the maintenance mechanism 60 moves from above the first support mechanism 51 to above the second support mechanism 52, and moves to the standby position. The controller 130 drives the shaft motor 59 (S521). When the shaft motor 59 is driven, the platen 104 rotates clockwise about the shaft 109A and takes the first posture.

The controller 130 drives the head motor 54 (S522). When the head motor 54 is driven, the head 38 moves from the uncapped position to the recording position. The controller 130 drives the conveyance motor 53 and the piezoelectric element (S523). When the piezoelectric element is driven together with the conveyance motor 53, the ink is discharged from the nozzle 39 and the image recording on the conveyed sheet S is resumed. The controller 130 determines whether the print job is completed (S524). When it is determined that the print job is not completed (S524: No), the controller 130 determines again whether the purge process start signal is received from the operation panel 44 (S503). When it is determined that the print job is completed (S524: Yes), the controller 130 ends the image recording accompanied by the purge process.

### Modification 3

In the embodiment described above, the case in which the number of nozzle surfaces 50 of the image recording device 100 is one is described as an example, and the configuration is not limited thereto. The head 38 of the image recording device 100a may include two heads of the first head 38a and the second head 38b. A liquid is supplied from a first tank 34a to the first head 38a, and a liquid is supplied from a second tank 34b to the second head 38b.

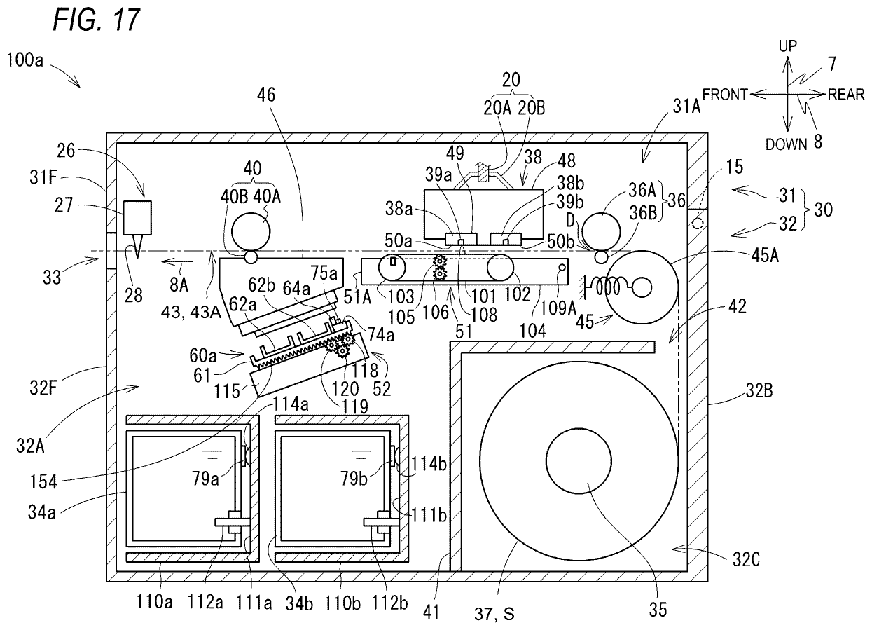

As shown in FIG. 17, the head 38 includes the first head 38a and the second head 38b. The first head 38a and the second head 38b are located side by side in the front-rear direction 8. The first head 38a has a rectangular parallelepiped shape. The first head 38a has, as a first nozzle surface 50a, a lower surface extending in the front-rear direction 8 and the left-right direction 9 on which a plurality of first nozzles 39a are formed. A dimension of the first nozzle surface 50a in the left-right direction 9 is substantially the same as a region of the sheet S where the image is recorded. The plurality of first nozzles 39a are arranged along the left-right direction 9 at intervals on the first nozzle surface 50a. The first nozzle surface 50a and a second nozzle surface 50b face the platen 104 at the image recording position.

The second head 38b is located behind the first head 38a. The second head 38b has, as the second nozzle surface 50b, a lower surface extending in the front-rear direction 8 and the left-right direction 9 on which a plurality of second nozzles 39b are formed. The second nozzle surface 50b has a height same as that of the first nozzle surface 50a. Since other configurations of the second head 38b are the same as those of the first head 38a, a detailed description thereof is omitted. The second head 38b moves together with the first head 38a when the head 38 is driven in the up-down direction 7 by the head motor 54.

A first mounting case 110a and a second mounting case (110b) are located in front of and below the housing 30. The first tank 34a is attachable to and detachable from the first mounting case 110a. The first tank 34a can be connected to the first head 38a by an ink tube. A first contact point 114a is located on an end surface 111a of the first mounting case 110a.

When the first tank 34a is mounted in the first mounting case 110a, the first contact point 114a is electrically connected to a first IC board 79a of the first tank 34a. The controller 130 can detect that the first IC board 79a is connected to the first contact point 114a. Latex ink is stored in the first tank 34a.

Similar to the first mounting case 110a and the first tank 34a, the second tank 34b is attachable to and detachable from the second mounting case 110b. The second tank 34b can be connected to the second head 38b by an ink tube. A second contact point (114b) is located on an end surface of the second mounting case.

When the second tank 34b is mounted in the second mounting case 110b, the second contact point 114b is electrically connected to a second IC board 79b of the second tank 34b. The controller 130 can detect that the second IC board 79b is connected to the second contact point. A pretreatment agent is stored in the second tank 34b. The pretreatment agent is applied to the sheet S in advance to facilitate fixing of the latex ink to the sheet S.

When the maintenance mechanism 60a is located at the maintenance position, a first cap 62a and a second cap 62b are located below the first head 38a and the second head 38b, respectively. The first cap 62a is in close contact with the first nozzle surface 50a of the first head 38a at the capped position when the maintenance mechanism 60a is at the maintenance position. Similarly, the second cap 62b is in close contact with the second nozzle surface 50b of the second head 38b at the capped position. The first cap 62a and the second cap 62b are spaced apart from each other in the front-rear direction 8.

The maintenance mechanism 60a includes a wiper blade 64a, a case 74a, and the support portion 75a. When the wiper blade 64a wipes the first nozzle surface 50a and the second nozzle surface 50b, a leading end portion of the wiper blade 64a is in contact with the first nozzle surface 50a and the second nozzle surface 50b.

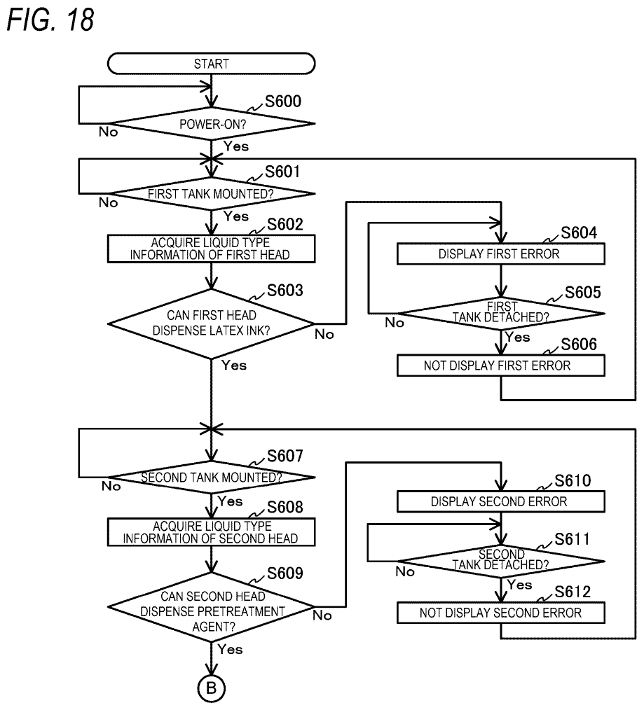

Hereinafter, control of the image recording device 100 performed by the controller 130 based on a type of liquid discharged from the first head 38a and the second head 38b by the controller 130 will be described with reference to FIGS. 18, 19, and 20A to 20E. At the start of the control, the maintenance mechanism 60a is located at the standby position, and the head 38 is located at the recording position. The platen 104 is in the first posture, and the case 74a is located at the lower position.

First, the control of the image recording device 100a related to attachment and detachment of the first tank 34a and the second tank 34b will be described with reference to FIGS. 17 and 18. The controller 130 determines whether a signal for turning on the power of the image recording device 100 is received from the operation panel 44 (S600). When the power-on signal is not received (S600: No), the controller 130 continues the determination until the power-on signal is received. When it is determined that the power-on signal is received (S600: Yes), the controller 130 determines whether a signal indicating that the first tank 34a is mounted is received from the first contact point 114a (S601). When the signal from the first contact point 114a is not received (S601: No), the controller 130 continues the determination until the signal from the first contact point 114a is received. When it is determined that the signal from the first contact point 114a is received (S601: Yes), the controller 130 acquires liquid type information of the first tank 34a from the first IC board 79a (S602).

The controller 130 determines whether the liquid type information in the first tank 34a is a polymer-containing liquid (an example of first information) (S603). The liquid in the first tank 34a here is latex ink, which is the polymer-containing liquid. When it is determined that the liquid type information in the first tank 34a is not the polymer-containing liquid (S603: No), the controller 130 causes the display unit 44A to display a first error (S604).

The controller 130 determines whether the first IC board 79a and the first contact point 114a are electrically connected (S605). When it is determined that the first tank 34a remains mounted in the first mounting case 110a and the first IC board 79a and the first contact point 114a are electrically connected (S605: No), the controller 130 keeps the display of the first error (S604). When it is determined that the first tank 34a is detached from the first mounting case 110a and the first IC board 79a and the first contact point 114a are not electrically connected to each other (S605: Yes), the controller 130 does not display the first error (S606), and determines again whether the signal indicating that the first tank 34a is mounted in the first mounting case 110a is received from the first contact point 114a (S601). In step S603, when it is determined that the liquid type information of the first tank 34a is the polymer-containing liquid (S603: Yes), the controller 130 determines whether a signal indicating that the second tank 34b is mounted is received from the second contact point 114b (S607). When the liquid filled in the first tank 34a is the latex ink, the latex ink can be discharged from the first nozzles 39a of the first head 38a.

When the signal from the second contact point 114b is not received (S607: No), the controller 130 continues the determination until the signal from the second contact point 114b is received. When it is determined that the signal from the second contact point 114b is received (S607: Yes), the controller 130 acquires the liquid type information of the second tank 34b from the second IC board 79b (S608).

The controller 130 determines whether the liquid type information in the second tank 34b is a polymer-free liquid (an example of second information) (S609). The liquid in the second tank 34b is a pretreatment agent and a polymer-free liquid. When it is determined that the liquid type information in the second tank 34b is not the polymer-free liquid (S609: No), the controller 130 causes the display unit 44A to display a second error (S610).

The controller 130 determines whether the second IC board 79b and the second contact point 114b are electrically connected (S611). When it is determined that the second tank 34b remains mounted in the second mounting case 110b and the second IC board 79b and the second contact point 114b are electrically connected (S611: No), the controller 130 keeps the display of the second error. When it is determined that the second tank 34b is detached from the second mounting case 110b and the second IC board 79b and the second contact point 114b are not electrically connected (S611: Yes), the controller 130 does not display the second error (S612), and determines again whether a signal indicating that the second tank 34b is mounted in the second mounting case 110b is received from the second contact point 114b (S607).

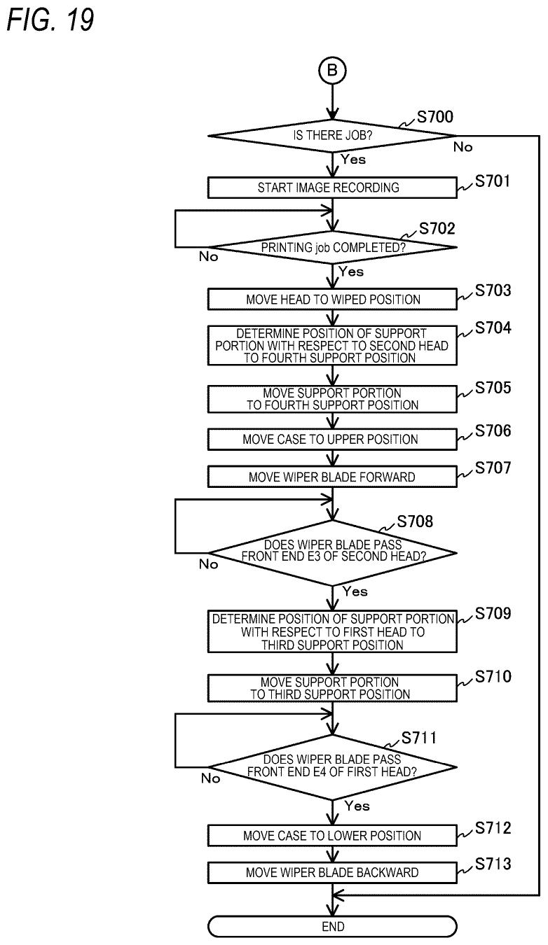

When it is determined that the liquid type information in the second tank 34b is the polymer-free liquid (S609: Yes), the controller 130 starts wiping of the first head 38a and the second head 38b as shown in FIG. 19. When the liquid filled in the second tank 34b is the pretreatment agent, the pretreatment agent can be discharged from the second nozzles 39b of the second head 38b.

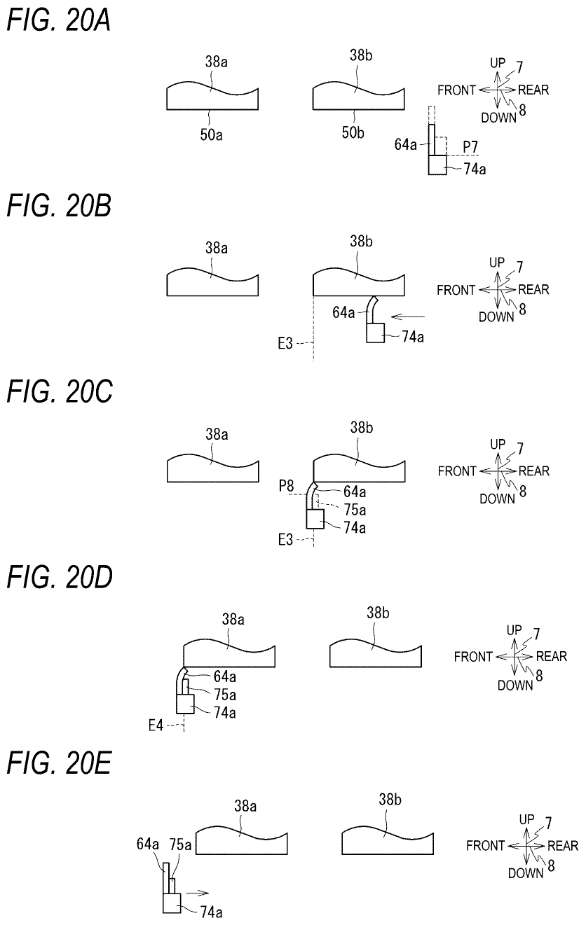

Next, control of the maintenance mechanism 60 by the controller 130 when the maintenance mechanism 60a wipes the first head 38a discharging the latex ink and the second head 38b discharging the pretreatment agent will be described with reference to FIGS. 19 and 20A to 20E. In FIGS. 20A to 20E, the description of the position sensor 76 is omitted.

First, the controller 130 determines whether there is a job to be printed in the image recording device 100a (S700). When it is determined that there is no job to be printed (S700: No), the controller 130 ends the control of the maintenance mechanism 60a to wipe the first head 38a and the second head 38b. When it is determined that there is a job to be printed (S700: Yes), the controller 130 drives the conveyance motor 53 and the piezoelectric element (S701). When the piezoelectric element is driven together with the conveyance motor 53, ink is discharged from the first nozzles 39a and the second nozzles 39b, and an image is recorded on the conveyed sheet S.

The controller 130 determines whether the print job is completed (S702). When it is determined that the print job is not completed (S702: No), the controller 130 continues the determination until the print job is completed. When it is determined that the print job is completed (S702: Yes), the controller 130 drives the head motor 54 (S703). When the head motor 54 is driven, the first head 38a and the second head 38b move from the recording position to the wiped position.

The controller 130 determines a fourth support position P7 of the support portion 75a in the up-down direction 7 (S704). The fourth support position P7 is a height of the support portion 75a when wiping the second nozzle surface 50b. The fourth support position P7 is set in advance and stored in the ROM 132 or the EEPROM 134, and is determined based on the fact that the liquid to be discharged is the pretreatment agent. As shown in FIG. 20A, the fourth support position P7 in Modification 3 is a position at which the support portion 75a is accommodated in the case 74a, and an upper end of the support portion 75a coincides with an upper end of the case 74a in the up-down direction 7. The controller 130 drives the support portion driving motor 86 (S705). When the support portion driving motor 86 is driven, the cam 87 rotates, and as shown in FIG. 20A, the support portion 75a is moved to the fourth support position P7.

The controller 130 drives the up-down driving motor 92 (S706). As indicated by a broken line in FIG. 20A, when the up-down driving motor 92 is driven, the case 74a is moved to the upper position by the ball screw mechanism 88. At this time, the upper end of the wiper blade 64a is located above the second nozzle surface 50b. The controller 130 drives the first motor 55 (S707). When the first motor 55 is driven, the maintenance mechanism 60a moves forward, as shown in FIG. 20B. When the maintenance mechanism 60a moves forward, the position of the wiper blade 64a in the front-rear direction 8 is detected based on a signal from the encoder 82.

The controller 130 determines whether the wiper blade 64a passes a front end E3 of the second head 38b based on the output signal of the encoder 82 (S708). Here, the front end E3 is a position indicated by a broken line in FIG. 20B. When it is determined that the wiper blade 64a does not pass the front end E3 (S708: No), the controller 130 continues the determination until the wiper blade 64a passes the front end E3. As shown in FIG. 20C, when it is determined that the wiper blade 64a passes the front end E3 (S708: Yes), the controller 130 determines a third support position P8 of the support portion 75a in the up-down direction 7 (S709). The third support position P8 is set in advance and stored in the ROM 132 or the EEPROM 134, and is determined based on the fact that the liquid to be discharged is the latex ink. The controller 130 drives the support portion driving motor 86 (S710). When the support portion driving motor 86 is driven, the cam 87 rotates, and the support portion 75a is moved to the third support position P8 as indicated by a broken line in FIG. 20C.

The controller 130 determines whether the wiper blade 64a passes a front end E4 of the first head 38a based on the output signal of the encoder 82 (S711). Here, the front end E4 is a position indicated by a broken line in FIG. 20D. When it is determined that the wiper blade 64a passes the front end E4 (S711: No), the controller 130 continues the determination until the wiper blade 64a passes the front end E4. As shown in FIG. 20D, when it is determined that the wiper blade 64a has passed the front end E4 (S711: Yes), the controller 130 drives the up-down driving motor 92 (S712). When the up-down driving motor 92 is driven, as shown in FIG. 20E, the case 74a is moved to the lower position by the ball screw mechanism 88. At this time, the upper end of the wiper blade 64a is located below the first nozzle surface 50a. The controller 130 drives the first motor 55 (S713). When the first motor 55 is driven, the maintenance mechanism 60a is moved rearward as indicated by an arrow in FIG. 20E to end the control.

### Operation and Effect of Modification

The controller 130 determines the third support position P8 of the support portion 75a when the liquid type information of the first head 38a is the latex ink. As the support portion 75a moves from the fourth support position P7 to the third support position P8, a deformation amount of the wiper blade 64a when wiping from the first nozzle surface 50a to the second nozzle surface 50b changes, and the pressing force against the first nozzle surface 50a changes according to the deformation amount of the wiper blade 64a. The ink adhering to the first nozzle surface 50a is easily solidified. The pressing force of the wiper blade 64a against the first nozzle surface 50a can be set in advance so as to be an appropriate pressing force according to the type of ink without repeating the process of performing user cleaning. Therefore, a time required for the image recording and consumption of the sheet S and the ink can be reduced.

However, since the polymer-containing liquid is easily solidified, the polymer-containing liquid strongly adheres to the first nozzle surface 50a, and the support portion 75a can be adjusted so that the third support position P8 with respect to the first nozzle surface 50a is closer than the fourth support position P7 with respect to the second nozzle surface 50b. Therefore, the pressing force of the wiper blade 64a is larger when the ink is the polymer-containing liquid than when the ink is the polymer-free liquid. Therefore, the ink solidified by the wiper blade 64a can also be reliably wiped. Specifically, the polymer-containing liquid does not have redispersion characteristics and remains fixed to the first nozzle surface 50a. However, since the pressing force of the wiper blade 64 is adjusted to be strong, the wiper blade 64 scrapes off the solidified ink while being in close contact with the first nozzle surface 50a without going over the solidified ink during wiping.

When wiping the second head 38b in which a liquid to be discharged is a polymer-free liquid, the support portion 75a is in a state of being accommodated in the case 74a.

The polymer-containing liquid can be discharged exclusively from the first head 38a, and the polymer-free liquid can be discharged exclusively from the second head 38b. Therefore, by adjusting the position of the support portion 75a such that the pressing force of the wiper blade 64a against the first head 38a is stronger than that of the second head 38b, it is possible to reliably wipe the solidified ink on the first nozzle surface 50a. In addition, the polymer-containing liquid and the polymer-free liquid can be prevented from being mixed in the first nozzles 39a and the second nozzles 39b.

Since the latex ink can be discharged from the first head 38a and the pretreatment agent can be discharged from the second head 38b, the latex ink can be applied to the sheet S and the latex ink can be fixed on the sheet S after the pretreatment agent is applied.

### Other Modifications

In the above-described embodiment, the case in which the case 74 is driven in the up-down direction 7 by the ball screw mechanism 88, the support portion 75 is separately driven in the up-down direction 7 by the cam 87, and the maintenance mechanism 60 is further driven in the front-rear direction 8 by the gear 106 is described as an example. However, the case 74, the support portion 75, and the maintenance mechanism 60 may be driven by a single mechanism. In this case, the position of the support portion 75 may be adjusted according to the type of ink used in the attached image recording device 100.

In the above-described embodiment, the case in which the wiper blade 64 is fixed to the case 74, and the support portion 75 is supported by the case 74 to be movable in the up-down direction 7 is described as an example, and the configuration is not limited thereto. The wiper blade 64 may be supported by the case 74 to be movable in the up-down direction 7. In this case, the support portion 75 may be fixed to the case 74, and in this case, the wiper blade 64 may move with respect to the support portion 75 in the up-down direction 7.

In the wiping process in the above-described embodiment, the case in which the wiping is performed with the head 38 located at the wiped position and the case 74 located at the upper position is described as an example, and the configuration is not limited thereto. The position of the case 74 with respect to the nozzle surface 50 may be adjusted only by moving the case 74 up and down, not by moving the head 38 in the up-down direction 7.

In the above-described embodiment, the case in which a lower end of the support portion 75 is supported by the cam 87, and the support portion 75 is adjusted in position in the up-down direction 7 by applying a rotational force to the cam 87 is described as an example, and the configuration is not limited thereto. The position of the support portion 75 may be adjusted in the up-down direction 7 by a ball screw or an electromagnetic valve.

In the above-described embodiment, the case in which the support portion 75 has a rectangular parallelepiped shape is described as an example, and the configuration is not limited thereto. The support portion 75 may have, for example, a trapezoidal shape. The support portion 75 may have a shape in which a rod-shaped member extending in the left-right direction 9 is supported on the case 74 from below. That is, the support portion 75 may be movable in the up-down direction 7 and may be any member that supports the curved wiper blade 64 while wiping the nozzle surface 50 at an upper end portion thereof.

In the above-described embodiment, the case in which the maintenance mechanism 60 moves at a constant speed of the first speed V1 when moving forward when wiping the nozzle surface 50 is described as an example, and the configuration is not limited thereto. The maintenance mechanism 60 may move while changing the speed when moving from the maintenance position to the wiping position. In addition, the maintenance mechanism 60 may be stopped while the position of the support portion 75 in the up-down direction 7 is moving. Further, the second speed V2 of the support portion 75 is not limited to a constant speed.

In the embodiment described above, the case in which the frame 29 located on the lower surface of the head 38 protrudes downward from the nozzle surface 50 and forms a step with the nozzle surface 50 is described as an example, and the configuration is not limited thereto. The edge of the head 38 may be recessed upward, and the frame 29 may be located above the nozzle surface 50. At this time, the frame 29 may be flush with the nozzle surface 50 in the up-down direction 7.

In the above-described embodiment, the case in which the head 38 does not move at the wiped position while the nozzle surface 50 is being wiped by the wiper blade 64 is described as an example, and the configuration is not limited thereto. The head 38 may move in the up-down direction 7 while being wiped by the wiper blade 64 to adjust the pressing force of the wiper blade 64.

In the above-described embodiment, the case in which the latex ink is used as the polymer-containing liquid, and the dye is used as the polymer-free liquid is described as an example. In Modification 1, the case in which the pretreatment agent is used in the polymer-free liquid is described as an example. However, it is needless to say that a liquid other than these liquids may be used as the polymer-containing liquid and the polymer-free liquid.

In Modification 3 described above, the case in which the fourth support position P7 is a position at which the support portion 75a is accommodated in the case 74a, and the upper end of the support portion 75a coincides with the upper end of the case 74a in the up-down direction 7 is described as an example, and the configuration is not limited thereto. At the fourth support position P7, the upper end of the support portion 75a may be located above the upper end of the case 74a.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A liquid discharge device comprising:
a head configured to discharge a liquid from a nozzle opening on a nozzle surface;
a wiper configured to be brought into contact with the nozzle surface at a front, in a first direction, surface of the wiper and be movable relative to the head in the first direction;
a support portion configured to support at least a rear, in the first direction, surface of the wiper and be movable relative to the wiper in a second direction intersecting the nozzle surface and the first direction; and
a controller configured to:
acquire an elapsed time from when the liquid is discharged from the nozzle;
determine, based on the elapsed time, a first support position which is a position of the support portion in the second direction; and
position the support portion at the determined first support position, and move the wiper relative to the head in the first direction.

2. The liquid discharge device according to claim 1,
wherein the controller is configured to:
determine the first support position based on the elapsed time being equal to or greater than a threshold value;
determine, based on the elapsed time being less than the threshold value, a position of the support portion in the second direction to be a second support position farther from the nozzle surface than the first support position; and
position the support portion at the determined first support position or the determined second support position, and move the wiper relative to the head in the first direction.

3. The liquid discharge device according to claim 1, further comprising:
a platen configured to be able to face the head,
wherein the support portion is configured to move in the second direction without changing a distance between the head and the platen in the second direction.

4. The liquid discharge device according to claim 2,
wherein the controller is configured to:
execute purge to discharge the liquid from the nozzle; and
position, after the purge is completed, the support portion at the second support position and moves the wiper relative to the head in the first direction.

5. A liquid discharge device comprising:
a head configured to discharge a liquid from a nozzle opening on a nozzle surface;
a wiper configured to be brought into contact with the nozzle surface at a front, in a first direction, surface of the wiper and be movable relative to the head in the first direction;
a support portion configured to support at least a rear, in the first direction, surface of the wiper and be movable relative to the wiper in a second direction intersecting the nozzle surface and the first direction;
a storage medium configured to store liquid type information related to the liquid discharged by the head; and
a controller configured to:
acquire the liquid type information from the storage medium;
determine, based on the liquid type information, a third support position which is a position of the support portion in the second direction; and
position the support portion at the determined third support position and move the wiper in the first direction relative to the head.

6. The liquid discharge device according to claim 5,
wherein the controller is configured to:
determine the third support position based on the liquid type information being first information;
determine, based on the liquid type information being second information different from the first information, the position of the support portion in the second direction to be a fourth support position farther from the nozzle surface than the third support position; and
position the support portion at the determined third support position or the fourth support position, and move the wiper relative to the head in the first direction.

7. The liquid discharge device according to claim 5, further comprising:
a platen configured to be able to face the head,
wherein the support portion is configured to move in the second direction without changing a distance between the head and the platen in the second direction.

8. The liquid discharge device according to claim 6,
wherein the first information is information indicating that the liquid is a polymer-containing liquid, and
wherein the second information is information indicating that the liquid is a polymer-free liquid.

9. The liquid discharge device according to claim 8, further comprising:
a case configured to be able to accommodate the support portion,
wherein the support portion is accommodated in the case at the fourth support position.

10. The liquid discharge device according to claim 8,
wherein the head includes a first head and a second head,
wherein the wiper is movable in the first direction relative to the first head and the second head,
wherein the first head is configured to discharge the polymer-containing liquid,
wherein the second head is configured to discharge the polymer-free liquid,
wherein the wiper is configured to move in the first direction relative to the first head with the support portion located at the third support position, and
wherein the wiper is configured to move in the first direction relative to the second head with the support portion located at the fourth support position.

11. The liquid discharge device according to claim 10,
wherein the polymer-containing liquid is latex ink, and
wherein the polymer-free liquid is a pretreatment agent of the latex ink.

12. A liquid discharge device comprising:
a head configured to discharge a liquid from a nozzle opening on a nozzle surface;
a frame surrounding the nozzle surface;
a wiper configured to be brought into contact with the nozzle surface at a front, in a first direction, surface of the wiper and the frame and be movable relative to the head in the first direction;
a support portion configured to support at least a rear, in the first direction, surface of the wiper and be movable relative to the head in a second direction intersecting with the nozzle surface and the first direction;
an encoder configured to output a signal indicating a relative position of the wiper relative to the head; and
a controller configured to:
position, on a condition that it is determined that the wiper is located in a boundary region between the nozzle surface and the frame based on the signal output from the encoder, the support portion at a fifth support position, and move the wiper relative to the head in the first direction, and
position, after the wiper is moved in the first direction, on a condition that it is determined that the wiper is not located in the boundary region based on the signal output from the encoder, the support portion at a sixth support position, and moves the wiper relative to the head in the first direction, the sixth support position being closer to the nozzle surface than the fifth support position in the second direction and faces the nozzle surface.

13. The liquid discharge device according to claim 12, further comprising:
a platen configured to be able to face the head,
wherein the support portion is configured to move in the second direction without changing a distance between the head and the platen in the second direction.

14. The liquid discharge device according to claim 13,
wherein the frame protrudes from the nozzle surface toward the platen in the second direction.

15. The liquid discharge device according to claim 12,
wherein a first speed at which the wiper moves relative to the head is constant.

16. The liquid discharge device according to claim 15,
wherein a second speed at which the support portion is moved in the second direction is higher than the first speed.

17. The liquid discharge device according to claim 5,
wherein the controller is configured to:
acquire an elapsed time from when the liquid is discharged from the nozzle; and
determine the third support position based on the liquid type information and the elapsed time.

18. The liquid discharge device according to claim 17, further comprising:
a platen configured to be able to face the head,
wherein the support portion is configured to move in the second direction without changing a distance between the head and the platen in the second direction.

19. The liquid discharge device according to claim 18,
wherein the controller is configured to:
execute purge for discharging the liquid from the nozzle; and
position, after the purge is completed, the support portion at a fourth support position farther from the nozzle surface than the third support position, and move the wiper relative to the head in the first direction.

20. The liquid discharge device according to claim 17, further comprising:
a frame surrounding the nozzle surface;
the wiper configured to be brought into contact with the nozzle surface and the frame; and
an encoder configured to output a signal indicating a relative position of the wiper relative to the head,
wherein the controller is configured to:
position, on a condition that it is determined that the wiper is located in a boundary region between the nozzle surface and the frame based on the signal output from the encoder, the support portion at a fourth support position farther from the nozzle surface than the third support position, and move the wiper relative to the head in the first direction; and
position, after the wiper is moved in the first direction, on a condition that it is determined that the wiper is not located in the boundary region based on the signal output from the encoder, the support portion at the third support position, and move the wiper relative to the head in the first direction.
